(19) United States
(12) Patent Application Publication
(10) Pub. No.: US 2025/0182225 A1
(43) Pub. Date: Jun. 5, 2025

(54) INTERACTIVE TOOL FOR INTELLIGENT COMPETITOR SET IDENTIFICATION AND COMPARISON FOR HOME BUILDER COMMUNITIES

(71) Applicant: Lennar Corporation, Miami, FL (US)

(72) Inventors: Alyssa Gomez, Miami, FL (US); Ben Locke, Boston, MA (US); Cesar Hernandez, Boston, MA (US); Jeff Moses, Ft. Lauderdale, FL (US); Richard Lemeul Winslow, IV, Tampa, FL (US); Yuri Ho, New York, NY (US)

(21) Appl. No.: 18/525,437

(22) Filed: Nov. 30, 2023

(51) Int. Cl. G06Q 50/16; G06F 3/0484; G06T 11/20

(52) U.S. Cl. CPC G06Q 50/165; G06F 3/0484; G06T 11/206; G06T 2200/24

(57) ABSTRACT

This disclosure provides systems, methods, and devices for control and management of production home builders. According to aspects, computerized tools described herein may enable home builders to react more quickly and consistently to new data relating to market forces and home buyer demand. Some features disclosed herein may enable and provide improved home demand classification, including classifying sets of homes in comparison to other homes in the market. In some aspects, the system receives home data for a first set of homes and a second set of homes, and based on the data, performs a multi-tiered comparison to identify comparable subsets of homes. Such operations may beneficially allow more accurate understanding of value indicators the housing market and how insights to market demand may be captured. Additionally, the system may output instructions to the home builder of actionable steps to improve home production and performance in the market.

### TECHNICAL FIELD

Aspects of the present disclosure relate generally to home construction and community management systems, and more particularly, to interactive tools for intelligent competitor set identification and comparison for home builder communities.

### BACKGROUND

Production home builders are entities that build homes and sell homes to consumers, typically in groups such as communities, and that often begin construction of homes in advance of having sold the homes. Such production home builders have conventionally underutilized data in their normal operations, such as managing home construction and home transactions (e.g., sales, financing, scheduling appointments, showings, etc.), identifying potential homebuyers, identifying new locations for communities, and determining performance metrics of these operations. For example, production home builders may underutilize data in planning construction of homes, pacing home construction, matching unoccupied homes with new homebuyers, or pricing the homes. In many cases, production home builders have not had access to some sources of data or have not taken advantage of such data sources. Even when relevant data is available, interpreting the data as it pertains to specific actions that the production home builder can undertake to improve performance can be difficult, as the various data is often too dense or seemingly unconnected to enable meaningful insights and specific actions to be derived. Conventional data analytics tools for home builders tend to merely aggregate or display available data, such as publicly available home sales data or interest rates. Such tools may inadequately identify trends in a given market for specific types of homes being constructed by the production home builder or their direct competitors, the tools may not take into account information related to the inventory and the production capabilities of the production home builder, and often such tools do not provide useful recommendations of prudent courses of action to production home builders to improve performance in view of their position in the marketplace and home production ecosystem. Although agents or principals of the production home builder may be trained to a limited extent to interpret the data and make appropriate decisions, such training can be costly and time-consuming and may result in undesirable variability in performance. Additionally, these trained agents may spend considerable time reviewing various data sources and using multiple different data analytics tools, resulting in an inefficient process for optimizing performance of the production home builder across many contexts.

In many cases, rather than taking actions based on a holistic, data-driven perspective, principals and agents of production home builders may make decisions based on a gut feeling or instinct. In some cases, this may mean making decisions because of incomplete information, leading to inconsistent use of data, inefficiencies, ineffective movement of inventory, and marginal losses. In other cases, such decisions may be wholly incorrect for a given situation, leading to lost profits, missed opportunities, and more significant losses. Additionally, relying on personal judgment to make decisions and communicate instructions to other agents of the production home builders may result in inefficiencies that increase response time to changes and production-to-sale times. For these reasons, production home builders that primarily rely on judgments of their agents to derive meaningful insights from disperse data sources in order to control entity performance may inadequately pace the performance, misunderstand how their homes compare to other homes on the market, misunderstand the impact of market demand data, inaccurately predict how their performance measures against the market and up to other home builders, and ultimately, price homes at values that do not reach their full potential. Therefore, there exists a need for data-driven, computerized tools for production home builders that can quickly process data from disparate data sources to determine and recommend valuable actions for a production home builder.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Aspects of this disclosure provide data-driven systems and methods to enable production home builders (also referred to herein as “home builders”) to pace performance more effectively, more accurately compare homes, and predict trends in the housing market.

Such functionality may be provided by computerized tools configured to provide automated performance analysis that derives meaningful insight from multiple different data sources and provides recommendations and automated performance of operations that enhance or optimize performance of a home builder, in some implementations by leveraging specifically configured machine learning and artificial intelligence that is trained on particular training data. According to some aspects, computerized tools are described as comprehensively intaking data from a variety of data sources, identifying data of relevant entities or home configurations with respect to the home builder, comparing the identified data to data associated with the home builder to generate relevant performance metrics, and determining actionable steps the home builder may take to achieve or optimize the performance metrics. The actionable steps may be based on insights derived from the data sources across multiple contexts and in real-time, or near real-time, and in some implementations actions may be automatically performed, to enable efficient responses by processes of the home builder to respond to changes in the marketplace or homebuying ecosystem. In some aspects, as will be described with greater detail herein, the computerized tools may be implemented using trained machine learning and/or artificial intelligence models, trained classifiers, unsupervised clustering engines, and other specifically configured models and logic that are trained on specific sets of training data to enable performance of the operations described herein.

In some aspects, the systems and methods of this disclosure may enable predictive analysis of home markets and performance metrics. For example, in some aspects, computerized tools configured to monitor and control operations of a home builder entity may dynamically determine a pace that the entity (e.g., the home builder) may target for selling homes in a given market or geographical area that takes into account home inventory, historic sales data, and other disparate information. In some aspects, such tools may enable more accurate comparisons between homes that may be highly relevant to the entity—including comparisons between homes sold by the entity and homes sold by a competitor—thereby prioritizing information for use in determining performance metrics. According to additional aspects, data-driven data tools may enable more effective price-setting for a home or a set of homes by taking into account the entity's position in the marketplace, available inventory and home building processes and schedules, and other factors derived from a combination of factors across multiple different contexts. According to some aspects, data driven tools may enable production home builders to more fully identify, capture, predict, and/or capitalize on home buyer demand data, which may provide valuable insights into the effectiveness of the home builder and its performance, leading to increased and sustained growth over time.

According to some aspects, a system in accordance with this disclosure may receive, at a first node of a network, home status data for a set of home builder communities. According to aspects, each of the home builder communities may include a respective set of homes, and the home status data may include at least a completion status for each home of the set of home builder communities, a set of historical performance data for the home builder communities, and a target metric.

According to aspects, the system may determine a set of target paces associated with the set of home builder communities based on the home status data. According to aspects, each target pace of the set of target paces may be associated with the completed home transactions for homes within a respective home builder community during a selected time period.

According to aspects, the system may receive, at the first node of the network, performance data associated with the set of home builder communities. According to aspects, the performance data may indicate historic sales or other home transactions associated with the set of home builder communities.

According to aspects, the system may compare the set of target paces to the performance data to determine a respective performance metric for each home builder community.

According to aspects, the system may transmit, to a second node of the network, a set of instructions corresponding to one or more home builder communities of the set of home builder communities, the set of instructions based on one or more performance metrics associated with the one or more home builder communities. According to aspects, the system may output to a graphical user interface (GUI) a representation of the performance metrics for the set of home builder communities.

According to some additional aspects, a system in accordance with this disclosure may receive, at a first node of a network, home data corresponding to a first set of homes and a second set of homes. According to aspects, the first set of homes may be associated with a particular entity and the second set of homes may be associated with one or more other entities. According to aspects, the home data may include, for each home of the first set of homes and the second set of homes, a respective plurality of parameter values. According to some aspects, the plurality of parameter values may include a location of the corresponding home, a price range of the corresponding home, dimensions of a home plan of the corresponding home, and a layout of the home plan of the corresponding home;

According to aspects, the system may receive, at the first node of the network, a user input that indicates a selected one or more homes of the first set of homes. According to aspects, the system may perform a multi-tiered comparison between a portion of the home data that corresponds to the one or more selected homes and a portion of the home data that corresponds to the second set of homes to generate comparison results. According to aspects, the system may select a subset of the second set of homes based on the comparison results.

According to aspects, the system may transmit, to a second node of the network, one or more instructions based on the subset of the second set of homes. According to aspects, the system may output, at the second node of the network, a graphical user interface (GUI) that includes a representation of the selected one or more homes, a representation of the subset of the second set of homes, and a representation of differences between the selected one or more homes and the subset of the second set of homes.

According to some additional aspects, a system in accordance with this disclosure may receive, at a first node of a network, home status data for a first plurality of homes. For example, the home status data may include at least a completion status for each home of the plurality of homes and a target metric for the first plurality of homes.

According to aspects, the system may receive, at the first node of the network, performance data for a second plurality of homes, the performance data indicating one or more historic performance values in the second plurality of homes;

According to aspects, the system may determine a pace for performing transactions related to (e.g., selling) the first plurality of homes during a time period by comparing the home status data with the performance data. According to aspects, the pace may include, for a plurality of increments of the time period, a number of homes of the set of homes to be sold during a respective increment, and where the pace is determined to prevent a change in the number of homes to be sold during any two consecutive increments of the plurality of increments from exceeding a first threshold.

According to aspects, the system may transmit a set of instructions to a second node of the network, the set of instructions based on the pace; wherein the set of instructions instruct a home builder to undertake one or more actions to achieve the pace, the one or more actions comprising adjusting a price for a home in the first plurality of homes, adjusting an advertising effort, modifying a performance metric, or a combination thereof.

According to some additional aspects, a system in accordance with this disclosure may receive, at a first node of a computer network, historical home sales data associated with a set of homebuilder communities. According to aspects, the system may receive, at the first node of the computer network, historical home demand data associated with the set of homebuilder communities. According to aspects, the system may extract a plurality of features from the historical home sales data and the historical home demand data to generate a set of feature vectors. For example, the set of feature vectors may include a numerical representation of the plurality of features extracted from the historical home sales data and the historical home demand data.

According to aspects, the system may provide the set of feature vectors as input to a trained machine learning (ML) model to generate a home sales prediction. The trained ML model may include a plurality of initial layers, a first final layer, and a second final layer. According to aspects, the home sales prediction may include a predicted number of home sales for a time period and a predicted change in home sales from a previous time period to the time period. According to aspects, the system may transmit, to a second node of the computer network, an instruction corresponding to the home sales prediction.

According to some additional aspects, systems in accordance with this disclosure may receive, at a first node of a network, a first set of parameter values corresponding to a first home associated with a first entity and a second set of parameter values corresponding to a set of homes associated with one or more other entities. According to aspects, the first set of parameter values may include a home location and a set of home plan data for the first home. According to aspects, the second set of parameter values may include, for each home in the set of homes, a respective home location and a respective set of home plan data.

According to aspects, the system may extract a first set of features from the first parameter values to generate a first feature vector. According to aspects, the first feature vector may include a numerical representation of the first set of features extracted from the first parameter values.

According to aspects, the system may provide the first feature vector to a trained machine learning (ML) model to identify one or more related homes to the first home. According to aspects, the trained ML model may be configured to assign homes to clusters in a multidimensional feature space based on corresponding features, where the clusters are defined by proximity between datapoints in the multidimensional space using a supervised learning routine.

According to aspects, the system may determine a target price for the first home based on prices of the one or more related homes. According to aspects, the system may transmit, to a second node of the network, an instruction based on the target price.

Thus, at a high level, computerized tools according to aspects described herein may enable production home builders to approach home production and market analysis from a more quantitative perspective. Systems and methods as described herein can provide home builders with a clearer understanding of their position in the home production ecosystem, including by determining and recommending actionable steps home builders can undertake to improve or optimize home production and performance. Such systems and methods may be integrated into an automated system with adaptive response speed. A benefit of such systems and methods is increased utility of system outputs (e.g., recommended courses of action or automated responses) because the outputs may be based on meaningful insights derived from different data sources and/or contexts. According to some aspects, these benefits can be further enhanced by leveraging specifically-trained machine learning and/or artificial intelligence models to perform efficient clustering, classification, or prediction tasks based on underlying patterns not recognizable by an agent of the home builder. Thus, computerized tools configured according to aspects may enable home builders to react more quickly and consistently to new data, using the data to more significantly impact the home builder's performance.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example intelligent home builder control and management system according to one or more aspects.

FIG. 2 is a diagram of a graphical user interface (GUI) illustrating examples of dynamic pacing performed by an intelligent home builder control and management system according to one or more aspects.

FIG. 3 is a diagram of a GUI illustrating examples of dynamic pacing performed by an intelligent home builder control and management system according to one or more aspects.

FIG. 4 is a block diagram illustrating an example of a machine learning (ML) forecasting model configured to predict performance for home builders according to one or more aspects.

FIG. 5 is a diagram of a GUI illustrating examples of home builder data tracking and performance prediction performed by an intelligent home builder control and management system according to one or more aspects.

FIG. 6 is a diagram of a GUI illustrating examples of market comparison and analysis performed by an intelligent home builder control and management system according to one or more aspects.

FIG. 7 is a diagram of a GUI illustrating examples of intelligent market comparison and analysis performed by an intelligent home builder control and management system according to one or more aspects.

FIG. 8 is a flow diagram illustrating an example process that supports dynamic performance pacing for home builders according to one or more aspects.

FIG. 9 is a flow diagram illustrating an example process that supports dynamic performance pacing for home builders according to one or more aspects.

FIG. 10 is a flow diagram illustrating an example process that supports home builder data tracking and performance prediction according to one or more aspects.

FIG. 11 is a flow diagram illustrating an example process that supports market comparison and analysis for home builders according to one or more aspects.

FIG. 12 is a flow diagram illustrating an example process of market comparison and analysis for home builders according to one or more aspects.

Like reference numbers and designations in the various drawings indicate like elements.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The following description is directed to some particular examples for the purposes of describing innovative aspects of this disclosure. However, a person having ordinary skill in the art will readily recognize that the teachings herein can be applied in a multitude of different ways.

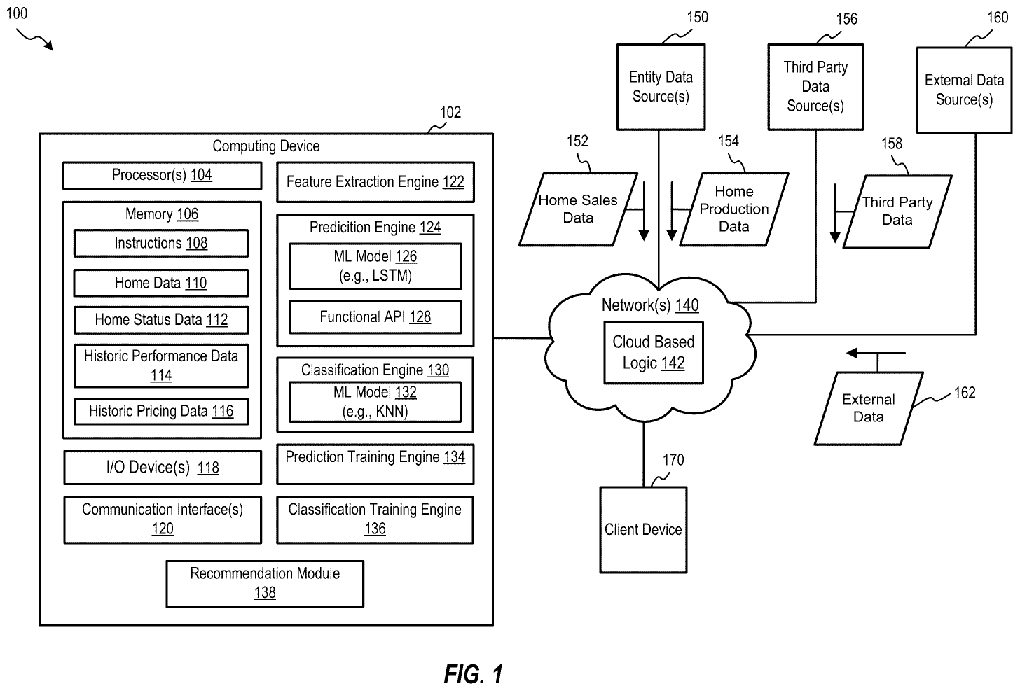

Referring to FIG. 1, a block diagram illustrating details of an example intelligent home builder control and management system according to aspects of the present disclosure is shown as a system 100. As described in more detail below, the system 100 is configured to intake data from disparate data sources, identify data of relevant entities or home configurations with respect to a production home builder, compare the identified data to data associated with the home builder to generate relevant performance metrics, and determine recommended actionable steps the home builder may take to achieve or optimize the performance metrics. The actionable steps may be based on insights derived from the data sources across multiple contexts. In some implementations, the system may be configured to the actionable steps in real-time, or near real-time. In some implementations, actions may be automatically performed, to enable efficient responses by processes of the home builder to respond to changes in the marketplace or homebuying ecosystem. In some aspects, as will be described with greater detail herein, the computerized tools may be implemented using trained machine learning and/or artificial intelligence models, trained classifiers, unsupervised clustering engines, and other specifically configured models and logic that are trained on specific sets of training data to enable performance of the operations described herein. Exemplary details regarding the above-identified functionality of the system 100 are described in greater detail below.

As illustrated in FIG. 1, the system 100 includes a computing device 102. The computing device 102 may be configured to receive data (e.g., home data) from a plurality of data sources and, based on insights derived from the data, to manage and control aspects of processes and systems of a home builder entity, including generating recommendations and/or instructions for agents of the home builder entity and/or for automatic performance. Several distinct aspects of this functionality are described throughout this disclosure. As an illustrative example, computing device 102 may be configured to determine a pace at which homes are constructed and sold based on data related to the homes, including construction status and availability for purchase. In this example, a pace for constructing and selling may be determined dynamically and automatically as updates to the data are made. Then, as a result of the updated pace, the computing device 102 may transmit to a node of a network an instruction to a home builder to perform an actionable step to achieve the pace—or in some implementations, the computing device 102 may perform the actionable step automatically. Actionable steps may include adjustments to processes in the home production or sales process to bring the home builder's performance into alignment with the pace by, for example, adjusting the availability of a home, modifying the price of the home, increasing marketing efforts related specifically to the home, and so on.

While shown as a computing device 102, the same or similar functionality may be provided by other implementations, such as over a network connection to one or more additional computing devices, or to one or more client devices (e.g., client device 170), through cloud based logic 140, through a distributed computing system, or other computing methods. As shown in FIG. 1, the computing device 102 may include one or more processors 104, a memory 106, one or more input/output (I/O) devices 118, one or more communication interfaces 120, a feature extraction engine 122, a prediction engine 124, a classification engine 130, a prediction training engine 134, a classification training engine 136, and a recommendation module 138.

The one or more processors 104 may include a central processing unit (CPU), graphics processing unit (GPU), a microprocessor, a controller, a microcontroller, a plurality of microprocessors, an application-specific integrated circuit (ASIC), an application-specific standard product (ASSP), or any combination thereof. The memory 106 may comprise read only memory (ROM) devices, random access memory (RAM) devices, one or more hard disk drives (HDDs), flash memory devices, solid state drives (SSDs), other devices configured to store data in a persistent or non-persistent state, network memory, cloud memory, local memory, or a combination of different memory devices. The memory 106 may also store instructions 108 that, when executed by the one or more processors 104, cause the one or more processors 104 to perform operations described herein with respect to the functionality of the computing device 102 and the system 100. The memory 106 may be further configured to store a plurality of datasets, including, as non-limiting examples, a dataset including home data 110 (e.g., data related to features of a home, such as, for example, home floorplan data, home geography data, and so on), a dataset including home status data 112, a dataset including historic performance data 114, and/or a dataset including historic pricing data. The datasets stored in the memory 106 may be stored particularly in one or more databases. To the extent that the memory 106 includes databases, the databases may store data associated with operations described herein with respect to the functionality of the computing device 102 and the system 100.

The I/O devices 118 may include one or more display devices, a keyboard, a stylus, a scanner, one or more touchscreens, a mouse, a trackpad, a camera, a microphone, one or more speakers, haptic feedback devices, a printer, or other types of devices that enable a user to receive information from or provide information to the computing device 102. The communication interface(s) 120 may be configured to communicatively couple the computing device 102 to the one or more networks 140 via wired or wireless communication links according to one or more communication protocols or standards. According to aspects, the computing device 102 may be considered a node of the one or more networks 140. Connections between the various modules, engines, and components of the computing device 102, including between the one or more processors 104, the memory 106, and the one or more communication interfaces may also be considered nodes of the one or more networks 140. The forgoing reference to computing devices 102 as a node of the one or more networks 140 is provided as an illustrative example of nodes of the network, and not as a limitation. Other nodes of the one or more networks 140 may be included according to aspects of the present disclosure. For example, other nodes of the network(s) 140 may include nodes at the one or more client devices 170, nodes at the entity data source(s) 150, third party data source(s) 156, and/or eternal data source(s) 160, and/or a node or nodes at the cloud based logic 142. As will be appreciated by to persons of ordinary skill in the art, other nodes may be included in and/or connected to the network(s) 140, although they may not necessarily be illustrated by FIG. 1.

The computing device 102 may be configured to receive data from a plurality of data sources. For example, the computing device 102 may be configured to receive data from one or more entity data sources 150 (referred to herein collectively as “entity data sources 150”), from one or more third party data sources 156 (referred to herein collectively as “third party data sources 156”), from one or more external data sources 160 (referred to herein collectively as “external data sources 160”), or a combination thereof. According to some aspects, the computing device 102 may be configured to receive home sales data 152 and/or home production data 154 from the entity data sources 150. The entity data sources 150 may include data sources associated with an entity that owns, operates, or is otherwise associated with computing device 102. An entity may include, for example, a company or organization in the business of building and/or selling homes (e.g., a home builder or home production builder), a principal or agent of such a company, a subsidiary of the company (e.g., an entity that manages or sells a subdivision of homes from the same entity), a property management company, a contractor, or some combination thereof. Home sales data 152 may include data related to the sales of homes by the entity, including, as nonlimiting examples, home sales data produced internally by the entity, performance metrics related to the sale of homes, data related to the sale prices of homes, data related to internally tracked quotas, goals, and/or changes to sales efforts, data related to marketing efforts for the entity, data related to sales forecasts and predictions, data related to cancellations, data related to pacing and the like. Home production data 154 may include data related to the production of homes by the entity, including, as non limiting examples, a number of homes currently under construction, a number of homesites (e.g., lots) planned for future home construction or otherwise owned by the entity, data related to the completion status of homes being built by the entity (e.g., how many days a given home has until it is scheduled to be completed, or for how long the home has been completed, or how long the home has been under construction), a number of homes available for purchase (e.g., including completed homes and/or homes scheduled to be completed but still under construction), data regarding the costs of construction, data regarding locations of available homes, data regarding layouts or configurations of available homes, or a combination thereof. In some aspects, various other data may be received from data sources associated with the entity, including, for example, data related to business metrics associated with the entity, performance targets, data regarding leads, data regarding visits to a website associated with the entity, data regarding sales efforts, data regarding advertising efforts, data regarding returns on investment from sales and/or advertising efforts, or any other data from the entity which may be useful in generating recommendations for home builder performance.

According to some aspects, the computing device 102 may be configured to receive third party data 158 from the third party data sources 156. For example, third party data 158 may include data identified by, collected by, and/or aggregated by a third party data collector, such as a commercial entity, a government entity, a news source, an information aggregation source, an online publication, or the like. Third party data 158 may include, as non-limiting examples, the list prices of homes offered by sellers not associated with the entity (e.g., competitor home builders and/or competitor home sellers), the number of homes sold in a given time period by a home seller, plan information related to one or more sets of homes (e.g., a count of bedrooms, a count of bathrooms, a building area, a lot area, a garage plan, a floorplan, etc.), geographical information related to one or more sets of homes (e.g., including a an address, a school district, a county, a state, a type of street), and/or home listings and sales information from a commercial entity that monitors and provides regional or nation-wide home information.

According to some aspects, the computing device 102 may be configured to receive external data 162 from the external data sources 160. According to some aspects, the external data 162 may include data obtained through the use of one or more web crawlers or one or more web scrapers, or received (e.g., streamed, downloaded, etc.) from one or more data providers. In some aspects, the external data 162 may include publicly available information, such as information from government agencies, information from real estate websites or search engines, information published by banks or other financial institutions, information from social media, other information, or a combination thereof. Some non-limiting examples of external data that may be collected and/or received include data regarding interest rates (e.g., the federal interest rate), data regarding banking rates, data regarding mortgage buy-out rates, housing costs data, construction material cost data, and so on. According to aspects, data may be received by the computing device 102 from the various data sources through one or more networks 140, through a wireless connection, through a wired connection, through some other means of informationally connecting a data source to a computing device, or through some combination thereof.

Computing device 102 may include one or modules that enable the computing device 102 to intake data from the various data sources, identify data of relevant entities or home configurations with respect to a production home builder, compare the identified data to data associated with the home builder to generate relevant performance metrics, and/or determine recommended actionable steps the home builder may take to achieve or optimize the performance metrics for home builders in accordance with aspects of the disclosure. Such modules may include specifically configured hardware, firmware, instructions, logic, or a combination thereof, and may be particularly implemented or executable to enable the particular operations described herein. FIG. 1 illustrates several exemplary modules, including a feature extraction engine 122, a prediction engine 124, a classification engine 130, a prediction training engine 134, a classification training engine 136, and a recommendation module 138.

According to aspects, feature extraction engine 122 may be configured to extract features from data received by the computing device 102. In some implementations, extracting features from the data may include parsing the data and deriving or generating particular qualitive and/or quantitative features from the data. In some implementations, at least a portion of the features extracted from the data may be formatted in a vector representation of the features (e.g., a feature vector). For example, data may be parsed by the feature extraction engine 122 and stored or discarded as may be necessary for supporting the operations described herein. The feature extraction engine 122 may be configured to identify features from the data based on context. For example, the feature extraction engine 122 may identify relevant features from the data based on a location within the data sources associated with the data, based on metadata associated with the data, based on similar data previously identified, based on one or more sets of contextual rules, or based on some other method for identifying features from data based on context. Features extracted from the data may include, as nonlimiting examples, representations (e.g., numeric representations) of a quantity and/or quality embodied in, related to, corresponding to, and/or derived from the data. Such features may include or correspond to one or more portions of data, either on their own or in combination with each other. Alternatively, or additionally, in some implementations, extracting the features may include organizing and/or formatting the features into a format capable of being provided as an input to one or more of the other modules discussed herein. In some implementations, extracted features may be weighted either prior to extraction or when used by other components of computing device 102. For example, feature extraction engine 122 may assign weights to various features, such as based on quantity, predetermined weights, detection (or lack of detection) of related features, type of input data, type of output data, or the like. As another example, any of the prediction engine 124, the classification engine 130, and/or the recommendation module 138 may be configured to receive the features output by feature extraction engine 122 and to assign their own respective weights to the features based on factors specific to the receiving component. Alternatively, in some implementations, extracting the features may leave the features unweighted.

Recommendation module 138 may be configured to generate recommendations to a home builder based on insights derived from the data sources across multiple contexts and in based on the data. According to aspects described herein, the recommendation module may be configured to provide an instruction to a home builder to take an actionable step. According to aspects of the disclosure, such actionable steps may be determined to improve the market position of the home builder and provide for more efficient production and distribution of homes. According to some aspects, the recommendation module 138 may be configured to perform operations automatically, such as, update a GUI based on updates to underlying data or selections made by a user, transmit a report of a recommended course of action, update a module parameter, modify a price of one or more homes to a more optimized value, and/or adjust a marketing effort. These operations are provided by way of illustration and not of limitation to the functionality of recommendation module 138. For example, recommendation module 138 may be configured to provide instructions and/or perform operations in accordance with aspects of this disclosure described below. In some implementations, recommendation module 138 may include specifically trained machine learning models, including rule-based classifiers, configured to render recommendations based on data inputs (e.g., the results, outputs, and/or recommendations of other modules to the system). Alternatively, or additionally, recommendation module 138 may be configured to draw insights from a knowledge base to make useful recommendations.

Other modules and engines of the computing device 102 such as the prediction engine 124, classification engine 130, prediction training engine 134, and classification training engine 136 are described below in connection with their respective functionality as it relates to particular aspects of the disclosure.

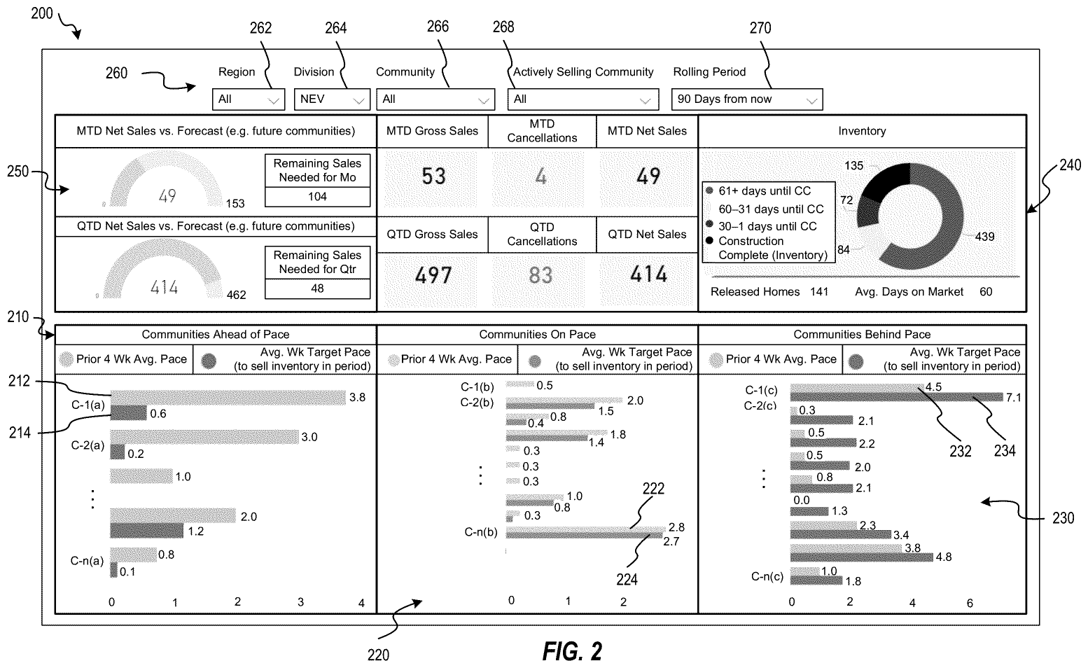

Reference is now made to FIG. 2, which is a diagram of a graphical user interface (GUI) illustrating examples of dynamic pacing performed by an intelligent home builder control and management system according to one or more aspects as GUI 200. GUI 200 illustrates examples of how data associated with an entity (e.g., a production home builder) may be displayed and/or dynamically modified in conjunction with operations to track and modify performance metrics for the entity. According to aspects, GUI 200 may be generated based on insights derived from the data sources across multiple contexts and in real-time, or near real-time based on data related to the entity and its performance. For example, as described above with reference to FIG. 1, the computing device 102 may generate GUI 200 based at least in part on data associated with the entity, (e.g., home sales data 152 and/or home production data 154) from the entity data sources 150 and/or from data related to the entity stored in memory 104 (e.g., home data 110, home status data 112, historic performance data 114, and/or historic pricing data 116). In an aspect, the data may be used to generate and/or populate at least portions of GUI 200 after the data is formatted and/or other intake operations performed by the feature extraction engine 122. Alternatively, in some aspects, the data may be used directly to generate and/or populate portions of the GUI 200.

GUI 200 may enable presenting and or modifying data related to the home builder entity's performance, including by determining and dynamically modifying the pace at which homes are to be constructed and/or sold. Dynamic modification of a performance pace or other performance metrics for home builders is important because the housing market can at times be volatile and difficult to predict, and thus tools embodied by aspects of the disclosure must be capable of adjusting to new data as it becomes available. For example, updates to the GUI 200 based on updates to the underlying data can be performed in real-time (e.g., as new data is received, updates may be performed) or periodically, including updates performed at regular intervals (e.g., every minute, every 5 minutes, every 10 minutes, every half hour, every hour, every 6 hours, every day, or at intervals longer than, shorter than, or in between the intervals listed here).

Dynamic data capture and corresponding dynamic updates to tools may enable a home builder to capture and better understand and adjust home production or home sales in response to and/or in anticipation of the market volatility. For a home builder who builds homes before they are under contract to be sold, it is particularly important to have dynamic tools that rapidly make changes in instructions to home builders as a result of shifts in market data because such tools enable the home builder to adjust home production construction efforts, as well as sales efforts, to more closely align with the market trends identified by the data. In many ways, shifts in the data may help a home builder understand its market position, pace, and home production cycle in the context of real-time or near real-time updates to data. According to some aspects, dynamically modifying the pace can enable a home builder to better price homes based on what the market may support. For example, if the computing device 102 determines that a community is ahead of pace (e.g., is selling homes faster than the pace) based on updates in received data, that may provide an indication that the home builder has additional pricing power in the market or that the home builder may be able to increase prices for homes in the community and the market will support that increase. Conversely, if the computing device 102 determines that a community is behind pace, that may indicate that prices for homes in the community are too high relative to the market.

GUI 200 of FIG. 2 includes graphical representations of home builder performance metrics and other data that may be used by the system. GUI 200 includes a graphical representation 210 of communities ahead of a given performance pace, a graphical representation 220 of communities achieving a given performance pace, and a graphical representation 230 of communities behind a given performance pace (collectively, referred to as the “graphical pace representations”). GUI 200 may also include displays of statistical data such as inventory representation 240 and statistical data representations 250, as well as a plurality of selectable elements 260. Each of the graphical pace representations includes a listing of communities associated with a home builder entity. Communities may include subsidiaries of the home builder entity, and may be organized as subdivisions, neighborhoods, and/or other sets of homes grouped together by the home builder entity. The communities in the graphical pace representations are referred to as C-1(a) through C-n(a) for graphical representation 210, C-1(b) through C-n(b) for graphical representation 220, and C-1(c) through C-n(c) for graphical representation 230. These numbers are illustrative of multiple communities being displayed in the GUI 200 based on respective performance metrics. In some implementations, the names of the communities may be used in place of the numbering scheme highlighted in the graphical pace representations. Additionally or alternatively, the communities may be listed by an indexing number particular to the entity. Although each of the graphical pace representations illustrate communities as being listed through a respective Nth community (e.g., C-n(a), C-n(b), and C-n(c)), this is done to simplify the idea that there may be multiple communities represented in each of the graphical pace representations rather than that there are the same number of communities represented in each of the graphical pace representations.

Referring to graphical representation 210, each community is represented corresponding to a graph showing a historical pace 212 and a target pace 214. Similar graphs and functionality are included in graphical representation 220 (e.g., historical pace 222 and target pace 224) and in graphical representation 230 (e.g., historical pace 232 and target pace 234). For simplicity, some elements of the graphs in the graphical pace representations have not been labeled. Principles discussed relative to a specifically labeled graph element should be deemed to apply to similar unlabeled graphs unless explicitly noted otherwise.

There are several factors that may influence how a pace may be determined. Such factors may be included in one or more of the models and/or tools according to aspects of the present disclosure. For example, the historical paces 212, 222, and/or 232 may be determined based on insights derived from data received from numerous data sources. According to aspects, one or more of the historical paces may be determined based on performance data related to a given community. For example, the performance data may correspond to a number of homes sold in a respective community over a previous period of time. Non-limiting examples of alternative or additional performance metrics that may be relevant to determining a historical pace may include a number of unique IP addresses from which requests to see content on a website associated with the entity are made during the previous period of time, a frequency at which the website associated with the entity is accessed in the previous period of time, a number of leads received related to potential home buyers in the previous period of time, historic performance in comparable communities (e.g., communities associated with the entity, communities associates with a competitor, and/or other comparable communities), and/or some other indicator of historic performance. In some implementations, the historical pace may be determined by averaging the number of homes sold over the previous period of time or over increments (e.g., intervals) of the previous period of time. For example, the historical paces 212, 222, and 232 are illustrated as corresponding to a prior four-week average pace. In some implementations, other periods of time may be considered for determining historical paces for the communities. For example, a historical pace may be determined over a previous week, over a previous two weeks, over a previous 6 weeks, over a previous quarter, or over some other period of time less than, greater than, or in between the examples listed here.

The target pace for each community (e.g., target paces 214, 224, and 234 of FIG. 2) may be determined based on insights derived from data received from one or more data sources. The target pace may be configured so that a home builder may effectively manage the production and sale of homes. Effective pacing is important for production home builders because it may enable more optimized management of the rate at which homes are constructed and sold, which can improve the margins and promote efficient home production. According to some aspects, the target pace for a respective community may be based on a rate at which homes may be sold in the respective community in order to reach a particular performance metric (e.g., a target metric). Additionally or alternatively, a target pace may be based on data associated with the completion status of homes in the given community (e.g., construction status, illustrated at least in part by inventory representation 240 of FIG. 2). For example, homes may be on a production pace determined by a construction timeframe, and how a sales pace matches or deviates from the production pace may indicate trends in the market related to how homes may be effectively priced to maximize profit margins. In some instances, an emphasis or a preference may be given to sell older homes (e.g., homes that have completed or nearly completed construction) before newer homes (e.g., homes that are further from completion). In some instances, this may help to maintain a production cycle of selling homes as they are produced. Additionally or alternatively, a target pace may be based on data associated with homes available to be sold in the given community, data associated with a rolling period of time, data based on the outputs and/or instructions of one or more modules of the system (e.g., the feature extraction engine 122, the prediction engine 124, the classification engine 130, and/or the recommendation module 138 of FIG. 1), and/or some other factor for determining the pacing for communities associated with the entity. In some exemplary aspects, the target pace may include the rate at which homes should be sold to make sure that homes are produced at approximately the same rate at which they are sold, or so that homes that are produced first may be sold first, or to sell all the available homes in a community, or to achieve a quota or a sales goal in a given period of time. According to aspects, a target pace for a given community may be determined based at least in part on the historical pace for the given community and a target metric for the given community. The target paces 214, 224, and 334 are illustrated as representing an average per week pace in a period of time. In some implementations, other periods of time may be considered for determining a pace for the communities. For example, a target pace may be determined for a week, two weeks, a month, a quarter, a year, or over some other period of time less than, greater than, or in between the examples listed here. Additional non-limiting examples of factors on which a pace may be based could include business goals of the home builder entity (e.g., growth goals, expansion goals, revenue targets, and so on) or indicators of demand drivers in an area, such as data regarding population increases, data regarding new home building developments in the area, data regarding the opening of new schools, businesses, or other points of interest in an area, and so on.

Determining a target pace may depend on the parameters for which a target pace is calculated. Users of the system, including agents of the home builder entity, may wish to adjust parameters, for example, to modify a target pace, to modify a performance metric or performance metric goal, to identify areas for focus which may be highlighted by the target pace, and/or to better understand the data by which a target pace for a community is determined. According to aspects, a target pace may be determined based on the period of time for which the target pace is needed. The period of time may be a static period of time, such as, for example, a month, a quarter, or a year. A pace based on a static period of time may determine how many homes, on average, should be sold during increments of the static period of time before the static period completes. Alternatively or additionally, the period of time may include a rolling period of time, or an period of time set a fixed length of time out from a current date that stays the fixed length of time as time advances (e.g., it rolls with the date). For example, a rolling period of time may be set at 90 days from a current date, as illustrated by the rolling period selectable element 270 in FIG. 2, or may be set to any useful rolling period of time, including 2 weeks from the current date, 4 weeks from the current date, 1 month from the current date, 2 months from the current date, 60 days from the current date, 120 days from the current date, a year from the current date, or some other period of time less than, greater than, or in between the examples listed here. In some additional or alternative implementations, a rolling period may be based on the rolling or ongoing construction of homes. For example, pace may be determined over a rolling period by the completion schedule for homes under construction. In some instances, new home constructions may be started as earlier constructions complete, as earlier constructions reach a specific level of completion, or as labor and/or materials become available for new constructions. In some such implementations, rolling periods may be determined based on the size of homes to be completed, based on home buyer demand in an area, and/or based on other community-specific factors. For example, larger homes may inherently take longer to construct than smaller homes, and rolling periods may need to account for such differences in construction schedules. Rolling periods may vary from community to community or even within a single community. A rolling period of time may enable the determination of a target pace based on optimizing home production and home sales together over an extended period of time. For example, the rolling period of time may operate as a time frame independent of weekly, monthly, quarterly, or yearly goals, or some other arbitrary time-bound goal, which may make it a more significant metric for determining optimal target paces for a community in the long run. In some implementations, the rolling period of time may be determined by a user by selecting a rolling period of time at selectable element 270. A target pace for one or more communities may be calculated (or recalculated, in the event that a target pace had already been calculated) in response to a user's selection of a rolling period of time. In some implementations, a user may adjust other parameters through one or more of the selectable elements 260. For example, a user may adjust parameters related to a region through a region selectable element 262, parameters related to a division through a division selectable element 264, parameters related to a community through a community selectable element 266, parameters related to an actively selling community through an actively selling community selectable element 268, or some combination thereof. Other selectable elements in addition to or in the alternative to those shown in FIG. 2 may be included to adjust parameters, including selectable elements for adjusting parameters such as, for example, home price ranges, dates that homes became available, floor plan details (e.g., dimensions of the home, number of bedrooms, number of bathrooms, size of lot, size of garage, and so on), which contractors are responsible for constructing the house. These and/or other parameters may also be adjusted in response to changes in data received. In some implementations, the system may automatically adjust data-based parameters as they are received. As a result of adjustments to the parameters, whether selected by a user or determined in response to newly received data, the system may then correspondingly adjust the target pace and/or historical pace. In some implementations, the system may automatically modify the GUI 200 to display the respective adjustments to the target pace and/or historical pace.

The target pace for a given community may be compared to the historical pace for community to determine whether the community is ahead of a target pace associated with community, meeting the target pace, or behind the target pace. Each community may then be grouped, ranked, and/or displayed on the GUI 200 based on whether the community is ahead of the target pace, meeting the target pace, or behind the target pace. In some implementations, comparing the historic pace to the target pace may include comparing the difference between the historic pace and the target pace to a threshold. For example, as illustrated by graphical representation 210, communities may be grouped and displayed as being ahead of the target pace if the historic pace is 0.5 or more home sales above the target pace. Similarly, as illustrated by graphical representation 220, communities may be grouped and displayed as meeting the target pace if the historic pace is within 0.5 average home sales of the target pace. Similarly, as illustrated by graphical representation 230, communities may be grouped and displayed as being behind the target pace if the historic pace is 0.5 or more home sales behind the target pace. These ranges are provided as an illustration only, and persons of skill in the art would understand that alternate threshold values could be used to a similar effect to determine how closely a historic pace aligns with a target pace. Graphical representations such as these are beneficial to system users because the user can tell at a glance which communities are on/ahead of/behind pace and make determinations as to pricing and/or marketing for those communities based on the pacing information presented.

The target pace may be dynamically determined. According to aspects, the target pace may be adjusted dynamically as inputs are received from a user's selection of one or more of the selectable elements 260. According to additional or alternative aspects, the target pace may be dynamically determined based on receiving updates to data from one or more data sources. According to some aspects, a community may be determined to no longer have a status of being either ahead of, meeting, or behind the target pace to a different one of the statuses, and a corresponding change for that community could be made to modify and adjust the GUI 200. For example, if a community was behind pace and then data was received indicating that the community had exceeded a performance metric such that it was now meeting a target pace, then that community could be moved from the graphical representation 230 of communities behind the target performance pace to the graphical representation 220 of communities meeting a target performance pace. Thus, the change could be dynamically updated in the GUI 200 as data is updated or as inputs to the GUI 200 are received.

GUI 200 may include an inventory representation 240, which may represent the distribution of homes available in a community grouped by a completion status. In many instances, production home builders may have more control over the price a home may be sold at if the home is sold earlier in its construction as opposed to later in its construction or after construction has been completed. To aid in determining pacing, the system 100 may be provided with data related to the completion status of homes in a community or a set of communities. For instance, the system 100 may receive home production data 154 from the entity data sources 150, including data regarding the completion status for the homes in the community or set of communities. According to some aspects, the completion status for a given home may indicate that the given home is scheduled to be built, within a first building phase, within a second building phase, within a third building phase, or fully built. As an illustrative example, homes may have a completion status within a first building phase if construction has started on the homes and there are 61 or more days remaining until a date by which construction is scheduled to be complete, as illustrated by the largest segment of the inventory representation 240. As a further illustrative example, homes may have a completion status within a second building phase if construction has started on the homes and there are 60 to 31 days remaining until a date by which construction is scheduled to be complete, as illustrated by the next clockwise segment of the inventory representation 240. As a further illustrative example, homes may have a completion status within a third building phase if construction has started on the homes and there are 31 days to 1 day remaining until a date by which construction is scheduled to be complete, as illustrated by the next clockwise segment of the inventory representation 240. And as a last illustrative example, homes may have a completion status of construction complete if construction has completed, as illustrated by the next clockwise segment of the inventory representation 240. In some implementations, homes that have completed and have not yet been sold may be considered inventory. In other implementations, inventory may include not only homes that have completed construction but also homes still under construction for up to a selected date out from a scheduled construction completion date. This may include or correspond to one of the delineations in the inventory representation 240 (e.g., 30 days out, 60 days out, etc.), but it need not be limited to one of those timeframes. A completion status corresponding to which homes are considered inventory may be determined based on data received related to a given community, division, or region, such as a target metric or based on selections input to the GUI 200 at selectable elements 260 by a user of the system or an agent of the home builder entity.

The GUI 200 may be further dynamically adjustable in its display of statistical data representations 250, in that the data represented may be dynamically updated as it is received by the system. The statistical data may include or be derived from data received from one or more data sources (e.g., as part of home sales data 152 received from entity data sources 150, or as part of any of the data stored in memory 104, etc.). Examples of the kind of data illustrated by the statistical data representations 250 may include representations of month to date (MTD) or quarter to date (QTD) sales vs. a forecasted number, or statistical data on MTD or QTD gross sales, cancellations, and/or net sales. Such statistical data may be useful for the insights that it may provide into the performance of an entity. Such data may also be useful to the extent that it can inform other processes, such as by aiding in determining target paces, or making market predictions, according to aspects described herein.

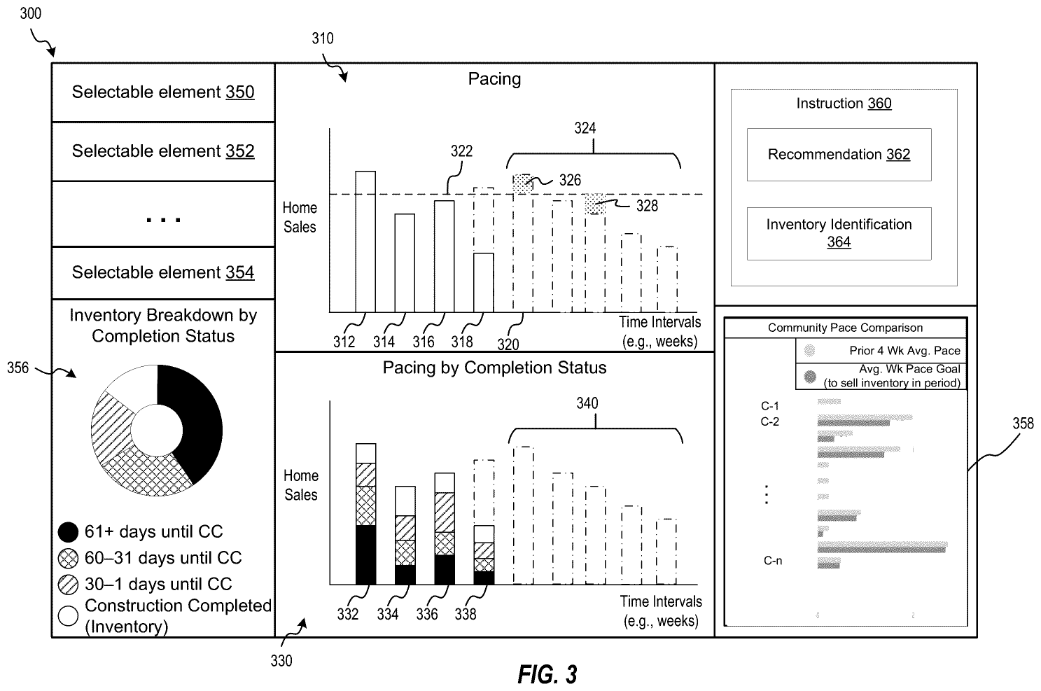

Reference is now made to FIG. 3, which illustrates a diagram of a GUI illustrating examples of dynamic pacing performed by an intelligent home builder control and management system according to one or more aspects, as a GUI 300. Like the example GUI 200 of FIG. 2, GUI 300 illustrates aspects of dynamically determining target paces for home builder performance based on insights generated based on data received from disperse data sources. GUI 300 may include various graphical elements for representing data, including a pacing graphic 310, a pacing by completion status graphic 330, a plurality of selectable elements, including selectable element 350, selectable element 352, and selectable element 354, a graphic representation 356 for showing homes based on completion status for homes, a graphical tool 358 for performing pace comparisons across communities, and an instruction 360.

According to aspects, GUI 300 may include a pacing graphic 310. Pacing graphic 310 may illustrate various aspects of pacing performed by an intelligent home builder control and management system (e.g., system 100 of FIG. 1). According to aspects, the pacing graphic 310 may be configured to display pacing information for a home builder. Pacing graphic 310 may include performance data for a home builder, represented over several time intervals. For example, the time intervals may represent periods of time for which data may be available, and may include data divided into daily intervals, one week intervals, two week intervals, monthly intervals, six week intervals, quarterly intervals, yearly intervals, and/or an interval of time less than, between, or greater than the intervals listed here. According to some implementations, the interval period may be adjusted in response to selection of one of the selectable elements 450, 452, or 454. For many implementations, a weekly period may be useful in providing enough time that efforts to achieve a pace within the week may be successful while being short enough that individual efforts to achieve the pace may remain significant and may be measured accordingly.

Pacing graphic 310 may include historical data for one or more previous intervals of time. For example, the data represented in time interval 412, time interval 414, and time interval 416 may include or correspond to historic performance data. Time interval 418 may correspond to a current interval of time. In some implementations, data associated with a home builder's performance in the current interval of time may include or correspond to the solid lined portion shown at 318, while a pace for the current time interval 318 may include or correspond to the dashed lined portion. This may display to the home builder how much progress has been made relative to the pace for the current time interval 318. For example, as home transactions are completed and/or cancelled, the pacing graphic 310 may be dynamically updated to reflect the corresponding change in performance. The pacing graphic 310 may also include information for future intervals of time 324 over which a pace is determined. The pacing graphic 310 has been described generally and without respect to specific values or proportions so that concepts may be better understood.

In many instances, production home builders may desire to maintain a steady rate for producing and selling homes. This may aid in producing homes at substantially the same rate as they are sold, which can lead to improved profit margins, more efficient production, and gradual increases in capacity to produce and sell homes over time. In some instances, production home builders may desire to sell homes in a first in, first out manner, such that the oldest homes produced may be sold first. This may not always be achieved in practice, but it may be a guiding principle for efficiency in production home building. To achieve a steady rate, a target pace 322 may be established. According to aspects, target pace 322 may be a rate at which homes may be produced and sold such that on average, the target pace may correspond to how many homes are expected to sell in a given week. In communities performing satisfactorily over their respective historic periods of time, the target pace 322 may be an average of the historic home data. For example, this method of pacing may be effective at maintaining a ready flow of home sales when home production cannot exceed a particular rate (e.g., because of material shortages or labor limitations, etc.,). For communities in which the historic performance has been less than satisfactory, the target pace may be determined to improve the performance for the community in a gradual or manageable way. For example, in response to a determination that a pace should increase or decrease to meet a performance metric, the target pace 322 may enable that change to occur more smoothly.

In some implementations, a target pace 322 may enable a more consistent performance outcome over time. Pace may be determined in many different ways, but in some implementations, production home builders may desire to sell homes that are older, or in later stages of production, before newer homes, as this can lead to more optimized revenue. Older homes can have increased margin risk compared to newer and under construction homes. Home builders may also desire to frontload home sales so that they may perform their efforts to achieve quotas or other performance metrics in advance of a respective deadline. Determining the target pace 322 may help to enable both of those objectives.

According to aspects, determining a target pace for a community may include accounting for the respective ages homes on the market in a community. For instance, in pacing graphic 330 and graphic representation 356 (e.g., an inventory breakdown), homes may associated with categories associated with the completion status (e.g., how far into the construction process a given home is). Homes in a community that have completed construction or are otherwise considered inventory (e.g., as described above with respect to FIG. 2) may be prioritized in determining a pace. For example, a component of the pace in a time period may include identifying inventory homes that should be prioritized for sale in the time period. According to aspects, to achieve the frontloading and smoothing goals, additional homes that are lower priority because they are further from completion may be identified and added to the pace. In some cases, selling inventory homes may be a top priority, but if every inventory home was included in the pace calculation for a present increment of time (e.g., the current week), the number of homes to be sold included in the pace could be unrealistic, and therefore it may be advantageous to push paced sales of some inventory homes out a few weeks when determining the target pace. For example, according to some aspects, the homes to be included in the target pace may be determined using a modified geometric series. For example, the pace may be determined using the series expression

$${\sum }_{i = 1}^{N} {a}_{i} {i}^{- k}$$

where aᵢ is the number of sales for a given week (or other relevant increment of time), and the range of i goes from 1 to N where N is the number of weeks to look forward for determining the pace, and k determines the maximum value of N such that the sum of the i terms are never less than 1. For example, if k=1 then N must be 1 otherwise the sum will be greater than 1. In some implementations, the value of N may be set at 7 (e.g., so that the model may look forward at a future 7 weeks). In some implementations, the value of k may be set at 2 or at 1.5 to balance sales urgency with smoothness in the pace.

Practically, the modified geometric series serves to take a first fraction of homes that must be sold in a first future week and add them to the present week's pace, and add a second fraction of homes, smaller than the first fraction of the homes, taken from a second future week after the first future week, and so on until the value of N is reached. Once a pace is determined for a first week, it may be applied again to the remainder of homes in the following weeks. This will have a smoothing effect over time because homes from each future period are incorporated each time the calculation is performed. This may also be referred to as a forward pace because it is forward looking to multiple weeks in the future.

On occasion, determining the forward pace may result in an uneven pace or a pace too high to be reasonably met in the period of time for a community. In cases like this, portions of the pace for a period of time that are higher than the target pace 322 may be displaced to periods of time in which the pace is lower than the target pace 322. For example, in pacing graphic 310, a portion 326 of the paced sales exceeds the target pace 322 for time interval 320, and so the extra portion 326 may be displaced to the shaded region 328, which has a pace less than the target pace 322. Such an adjustment may be repeated as needed until all paces fall within a threshold amount of target pace 322 (e.g., within a percentage of target pace 322), or in some implementations, until a predetermined number of displacements have occurred. In some implementations, these pacing determinations may be processed automatically by the computing device. In some implementations, pacing in this manner may better enable users to identify whether a community is ahead of, meeting, or behind the target pace 322, similar to the pacing determinations discussed relative to FIG. 2.

Additionally or alternatively, in some cases home builders may desire to pace homes such that a fixed number of homes to may be sold (e.g., all homes in a community) by the end of a specified period of time. In other cases, home builders may desire to frontload home sales to get ahead of anticipated demand, or to meet a business goal. In either case, a desirable pace may be designed to taper off the volume of homes paced over the period so that a home builder may be ahead of a cutoff. This tapering effect is suggested by the declining pace value illustrated over the pace values 340 shown in FIG. 3. One method for producing such a tapered pace may include applying a beta distribution to the homes to be sold to determine a tapered pace. For example, a beta distribution function may be applied having an alpha parameter equal to 1, and a beta parameter equal to 1.6. Such a beta distribution may thus serve both the frontloading and smoothing functions desired for the pace in some implementations.

Pacing determinations may help account for and adjust to unexpected changes in home inventory levels. For example, in an ideal case, homes would be produced and sold at substantially the same rate. In many cases, the ideal may not be possible using real-world circumstances and ideas. For example, homes may not be completed on schedule in all instances, or a home sale may be cancelled, or market conditions may change dramatically. These factors or others may disrupt home sales pacing, but dynamic determination of pace may allow for quick adjustment to unexpected changes.

In some implementations, pacing determinations may be dynamically adjusted based on data received and/or input to GUI at one or more of the selectable elements 350, 352, and 354. In some examples, the GUI may correspondingly be updated and caused to change as a result of inputs at one or more of the selectable elements 350, 352, and 354 or based on updated data received. As with other implementation described herein, any of the graphical elements discussed with reference to GUI 300 (e.g., pacing graphic 310, pacing graphic 330, community pace comparison 358) may also be selectable elements of the GUI in their own right. For example, selection of a pacing metric for a given interval of time from pacing graphic 310 may cause additional information to be displayed on the GUI related to the pacing, or may provide specific insights for a home or a community based on the pacing.

In some embodiments, pacing recommendations may be generated as an instruction 360. Alternatively, or additionally, instruction 360 may include a recommendation 362 of new pace, or of efforts that can be implemented to achieve a given pace. The instruction 360 may instruct a home builder to undertake one or more actions to achieve the pace. For example, the one or more actions may include adjusting a price for a home, adjusting an advertising effort for a community or set of homes, modifying a performance metric, or a combination thereof. In some aspects, the instruction 360 may include an identification 364 of recommended inventory to prioritize (e.g., a particular house or a particular set of homes). In some implementations, the recommended course of action may be performed automatically.

Returning to FIG. 1, computing device 102 includes a prediction engine 124. Prediction engine 124 may be configured to predict the performance of a production home builder by comparing performance data associated with the home builder with historic performance data and with data related to demand. According to aspects, the prediction engine 124 may be configured to forecast the number of homes sold per week across various communities. According to aspects, performance engine 124 may be configured to receive data after it has been received, handled, and/or formatted by the feature extraction engine 122. For example, the feature extraction engine 122 may receive historical performance data related to the entity from one or more data sources (e.g., from the entity data sources 150 or from data stored in the memory 106). Non limiting examples of historical performance data may include the number of homes available for purchase over a given period of time, the number of homes under construction over a given period of time, the number of homes remaining as inventory, home sales data over the period of time, sales prices over the period of time, pacing data over the period of time (e.g., performance pacing as determined according to aspects described above), a number of sales over the period of time, the ratio of successful transactions to cancellations over the period of time, some other relevant measure of performance over the period of time, or a combination thereof. The feature extraction engine 122 may additionally receive historical demand data from one or more data sources, including the entity data sources 150, the third party data sources 156, the external data sources 160, or from data stored in the memory 106. Non-limiting examples of historical demand data include leads data, customer inquiry data, website visit data, data from a third party data source, data from a source of streaming data, data identified by web crawlers, data from a proprietary data source, publicly available data, data acquired using an application programming interface (API), or a combination thereof. Feature extraction engine 122 may be configured to extract one or more features from the data into a set of one or more feature vectors. According to aspects, feature vectors may include a numerical representation of the features extracted from the data. For example, features relative to the temporal dynamics of the market at a point in time may be captured. Features extracted from the data may be scaled and/or standardized when put into the feature vectors to account for the variance in sales volume across different communities. The features may also be formatted to be provided into a specifically trained machine learning (ML) model. For example, in an aspect, each data record may be formatted as a time series snapshot of 5 weeks. Other time ranges for data features may be used as well. To get meaningful results from the trained ML model, the time range of the feature vector should include enough data (e.g., data over a long enough period of time) to account for data lags and make sure there is enough data present (e.g., significant enough data volume) to extract meaningful signals from the data as opposed to noise. In volatile market conditions, however, too much data (e.g., over a longer period of time) may cause the data or the features to be less predictive for current market environments. Thus, these factors should be balanced. Improvements in data capture or data accuracy, better understanding of connections between data features, reduction in lag, and/or improvements to models may enable accurate predictions to be generated with less input data.

According to aspects, prediction engine 124 may include or correspond to a trained ML model 126. The trained ML model 126 may be specifically trained to predict performance for the home builder by comparing performance data associated with the home builder with historic performance data and with data related to demand. According to aspects, the trained ML model 126 may include or correspond to one or more neural networks. For example, the trained ML model 126 may be implemented as a long short-term memory (LSTM) model. An LSTM model is a type of recurrent neural network that is capable of learning patterns and dependencies in sequential data. Advantages of an LSTM model over other trained ML models for predictions in accordance with aspects may include better performance in identifying and predicting long-term trends in data. An LSTM model may be configured to add lag to features of the model in order to generate accurate predictions. For example, the LSTM model may identify and base predictions on the appropriate amount of lag between demand data, such as website visits over a time period or a kept showing appointments, and conversions (e.g., completed sales). These advantages are provided for illustrative purposes, and not by way of limitation. Other types of trained ML prediction models may also be configured to perform sales predictions according to aspects of the disclosure.

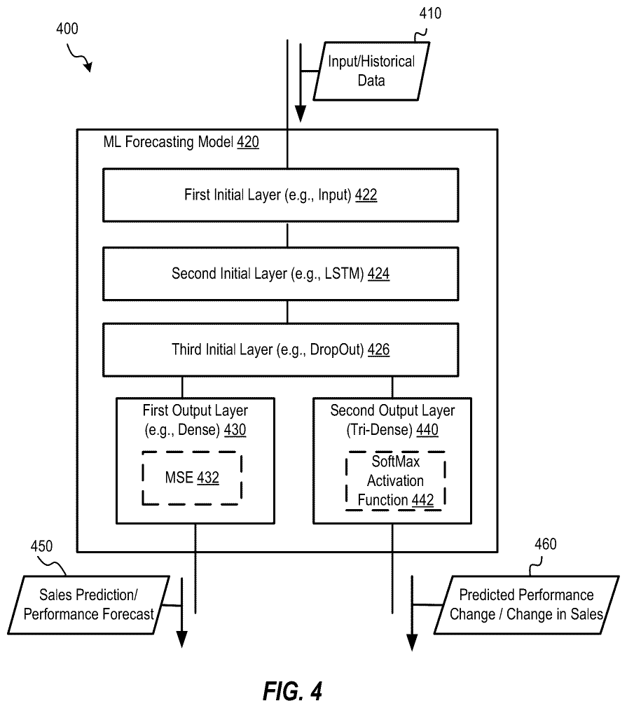

Reference is now made to FIG. 4, in which a block diagram illustrating an example of a machine learning (ML) forecasting model configured to predict performance for home builders according to one or more aspects is shown as ML model 400. In some implementations, ML model 400 may include or correspond to the trained ML model 126. At a high level, ML model 400 takes in an input 410 (which may include historical data), processes it through ML forecasting model 420, which may include or correspond to one or more neural networks, and produces two outputs: a performance forecast 450 (e.g., a sales prediction) and a predicted performance change 460 (e.g., a change in sales). More particularly, in some aspects, the input 410 may include feature vectors as generated by feature extraction engine 122. The ML forecasting model 420 may include multiple layers, including initial layers and output layers. For example, the ML forecasting model 420 may include a first initial layer 422 (e.g., an input layer), a second initial layer 424 (e.g., an LSTM layer), a third initial layer 426 (e.g., a Dropout layer), a first output layer 430 (e.g., a dense layer), and a second output layer 440 (e.g., a tri-output dense layer). The initial layers may be configured to mitigate overfitting by managing the model's complexity. The ML forecasting model 420 may bifurcate the predictive modeling into the two distinct outputs, the performance forecast 450 and the predicted performance change 460. According to aspects, a functional application programming interface (API) may be used to allow shared usage of the initial layers across the output layers. The functional API may include or correspond to functional API 128 of FIG. 1. For example, the Keras functional API may be used to perform the bifurcation and to provide the outputs of the initial layers to the output layers. Use of a functional API may enable effective data transfer between layers. Conversely, shared use of the initial layers may not be possible for a sequential API, as a sequential API would not typically allow for sharing the initial layers' weights across the output layers like a functional API does.

According to aspects, the first output layer 430 may be a dense layer configured to predict the number of homes sold across a region (e.g., over a division including a plurality of home builder communities) in an upcoming period of time based on the historical data. For example, the first output layer 430 may be configured to predict the number of homes sold across a division over the upcoming week. Other periods of time may be used for predictions as well, although it should be noted that accuracy of the prediction may decrease the further ahead the prediction is configured to apply to. Similarly, smaller or larger segments of a home builder's region or division may be included, but especially for smaller divisions or subdivisions, (e.g., an individual home builder community) the volume of home sales typically sold from that community during a given week may be too small or susceptible to noise to accurately predict the number of homes that will sell in that community during that week. The predicted sales may be output as performance forecast 450. According to some implementations, the first output layer 430 may be configured to optimize a mean squared error (MSE) loss function, as is optionally illustrated as MSE function 432. Optimizing a MSE loss function may allow for more accurate predictions and matching between the model's predictions and the actual values.

According to some aspects, the second output layer 440 may be a tri-output dense layer configured to predict the change in the sales of homes per community in an upcoming period of time, based on the historical data. For example, the second output layer 440 may be configured to predict whether the number of homes sold in a community (or in a region, division, or other portion of the overall number of homes sold by a home builder entity) may result in an increase in home sales, a decrease in home sales, or no change in home sales in comparison to the previous week or weeks. Predicting the exact number of homes that will sell in a single community in a given week can be difficult. The small sample size of homes sold in a single community in a week means that predictions can be fairly prone to variability in the data. But identifying whether a community is expected to increase, decrease, or not change may be easier to predict from smaller sample data. The predicted change may be output as predicted performance change 460. In some implementations, the second output layer 440 may be equipped with a softmax activation function, as is optionally illustrated as softmax activation function 442. Softmax activation function 442 may be configured to generate a probability distribution from a vector output of the second output layer 442, corresponding to how the predicted sales are expected to change in the upcoming period of time. For example, the second output layer 442 may be configured to determine a first probability that the predicted change in home sales for the time period is an increase in home sales from the previous time period, a second probability that the predicted changes in home sales for the time period is a decrease in homes sales from the previous time period, and a third probability that the predicted changes in home sales for the time period do not change from the previous time period. According to aspects, the highest probability outcome may be selected as the final output of the second output layer 442. For example, the highest probability outcome may be selected using an argmax function.

According to aspects, the trained ML model 126 and/or the ML forecasting model 420 may be specifically trained by a prediction training engine 134. The specific training enables the model to perform its performance forecasting and performance change predictions. Prediction training engine 134 may be configured to provide the trained ML model 126 with a training dataset. The dataset may include data associated with the entity, (e.g., home sales data 152 and/or home production data 154) received or derived from the entity data sources 150, data associated with a third party (e.g., third party data 158) received or derived from the third party data sources 156, external data 162 received or derived from the external data sources 160 and/or from data stored in memory 106 (e.g., home data 110, home status data 112, historic performance data 114, and/or historic pricing data 116). The prediction training engine 134 may use all or a portion of these disperse data for training the trained ML model 126. In some implementations, for example, the training dataset may include historical sales data associated with the entity, historical demand data associated with the entity. As non limiting examples, the historical demand data may include website traffic for a website associated with the entity, data associated with leads for the entity, data associated with appointments made with the entity, data associated with mortgage buy-down rates used by the entity, historical sales data associated with one or more third parties (to the extent that it is available or known), and/or external data such as a federal mortgage interest rate.

In some implementations the entire trained ML model 126 may be trained using the Adam optimization algorithm. The Adam optimization algorithm may provide several benefits, including, that it is relatively straightforward to implement, is computationally efficient, has little memory requirements, may be well suited for problems that are large in terms of data and/or parameters. For example, the Adam optimization algorithm may converge to a prediction quickly when used for the massive number of features that may be included in sequenced data. Further, the Adam optimization algorithm may be well suited for problems with very noisy/or sparse gradients, like predictions in a housing market, which can be both volatile and prone to noise, given the comparatively low volume of sales of homes in a given community, even for large production home builders.

According to aspects, the training process may be orchestrated in two stages. In a first training stage, a number of epochs for training may be determined. For example, According to aspects, early stopping may be used to prevent overfitting by monitoring losses during validation. For example, early stopping may stop the first training stage when a monitored metric (e.g., a validation metric) has stopped improving. In some implementations, the first sign of no improvement may not be the best time to stop training, because the model may get slightly worse before getting much better. However, this can be accounted for by delaying the early stopping trigger in terms of the number of training epochs for which no improvement is seen. For example, in some implementations, if no improvement is seen over a number of epochs substantially to 10% of the total training epochs, this may be a sufficient delay to confirm early stopping should be applied. In a second training stage, the entire training dataset may be used to train the model for the number of epochs determined by the first stage (and tempered, as necessary by early stopping), and at a set learning rate.

The training and/or performance of the trained ML model 126 may be assessed on unseen data to test the model's predictive accuracy. The predictions made by the model may be unscaled to align with the original scale of the data (e.g., the scale of the data before it was scaled and/or standardized when input to the model). The predictions made by the trained ML model 126 may then be output in a useable format to a user of the system. For example, the predictions may be output to a graphical user interface (GUI). According to some aspects of the present disclosure, the predictions may also be provided to the recommendation module 138, which may generate one or more instructions to the home builder based on the prediction.

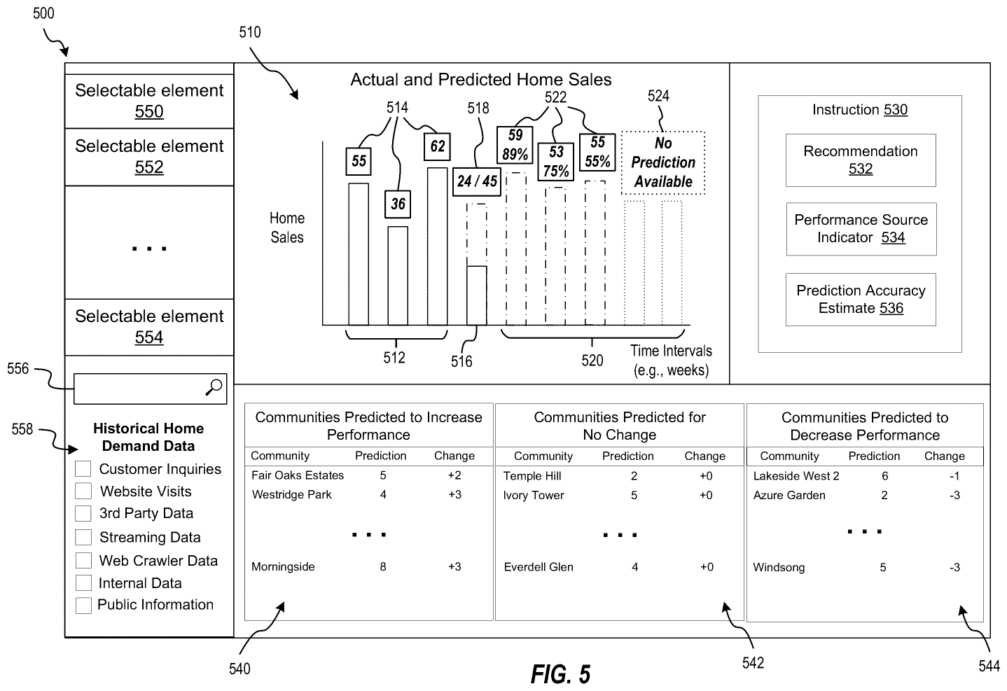

Reference is now made to FIG. 5, in which a diagram of a GUI illustrating examples of home builder data tracking and performance prediction performed by an intelligent home builder control and management system according to one or more aspects is shown as GUI 500. According to aspects, GUI 500 may be dynamically generated by computing device 102 based on insights derived from one or more data sources across multiple contexts, and in real-time, or near real-time. GUI 500 may further be generated and/or populated based on the outputs of the prediction engine 124. For example, GUI 500 may include a prediction graphic 510, an instruction 530, a predicted increase graphic 540, a predicted no change graphic 542, a predicted decrease graphic 544, a plurality of selectable elements, including selectable element 550, selectable element 552, and selectable element 554, a search bar 556, and a plurality of filters 558.

According to aspects, prediction graphic 510 may display historic performance and/or predicted performance for a set of homes. For example, the historic performance and/or predicted home performance displayed may include historic and/or predicted home sales for a set of homes, such as, for example, one or more home builder communities. According to aspects, the prediction graphic 510 may display predicted sales for a region or a division (e.g., a greater geographic area) of the home builder entity. Predictions of a number of sales tends to be easier for larger sources of home data (e.g., over a region) as opposed to in an individual community, which may be more difficult to predict with accuracy, due to the lower volume of home sales. Prediction graphic 510 may display a plurality of historic home data 514 for the set of homes corresponding to a plurality of previous intervals of time 512. Historic home data 514 may include or correspond to actual home sales for the set of homes over the previous intervals of time 512. Although illustrated as an example here with three historic intervals of time 512, more or fewer intervals of time may be displayed according to various aspects. The number of historic intervals 512 displayed may, but need not necessarily, correspond to the historical data provided to the prediction engine 124 as described above. Predicted performance may be determined by a prediction engine 124 as described herein. For example, predictions as to the number of home sales that may occur in a future interval of time may include a prediction 518 for a current interval of time 516, or one or more predictions 522 for one or more future intervals of time 520. In some implementations, the prediction engine 124 may only make predictions for one future interval of time (e.g., one week). Alternatively, the prediction engine 124 may make predictions for multiple intervals of time. Predictions made for the current interval of time 516 may be displayed relative to the actual performance achieved thus far in the current interval of time 516. For example, prediction 518 may indicate that a prediction of 45 sales was made, and that 24 of the 45 predicted sales have been made so far. In some implementations, the actual number may be dynamically updated as new sales are made and/or cancelled. In some implementations, the prediction for the current interval of time 516 may be recalculated as the interval of time draws to a close, so that the prediction may match the actual. Alternatively, the difference between a predicted and actual performance value may be maintained for validation and/or retraining purposes for the prediction engine 124. Future predictions 522 may include, in some implementations, an estimation of the prediction accuracy. For example, a first future prediction illustrated in FIG. 5 shows a predicted performance of 59 home sales with an 89% estimated accuracy. In some implementations, the prediction engine 124 may not be configured to estimate the accuracy of its predictions, and so such information may not be included. At some point, a future prediction may not be made for a future time interval. This may be, for example, because data may not be available for determining a performance value that far into the future; or because the model may not be equipped to render predictions that far out. In such implementations, no prediction may be presented (e.g., as at 524).

Additionally, or alternatively, GUI 500 may include an instruction 530. Instruction 530 may include actionable steps that a home builder may undertake. Instruction 530 may be based on the predictions determined by the predictive engine 124, either on their own or as provided to the recommendation module 138. The instruction 530 may include a recommendation 532 that an entity (e.g., home builder) undertake some actionable step. Non limiting examples of the recommendation 532 may include a recommendation to raise or lower the price of a given home, a recommendation to increase or decrease a construction rate for a home, a recommendation to acquire additional property lots, a recommendation to adjust a pacing value for a given home, or a combination thereof. The instruction 530 may further include a report of the predicted number of sales and/or a report of the predicted change in the number of homes. According to some aspects, the instruction may provide a performance source indicator 534. A performance source indicator may offer insights into how a predicted performance was determined. For example, if a parameter or datapoint provided to or used by the prediction engine 124 was particularly weighty in determining the predicted value, an indicator of the source of that parameter or datapoint may be provided. In some instances, this may provide insights into effective measures that may be taken to improve performance. For example, it may indicate that data associated with a given lead was more likely to indicate a completed sale than data associated with website traffic. Additionally or alternatively, in some instances, the prediction engine 134 may identify connections, patterns, or predictions that a human may not have noticed in the data. The performance source indicator 534 may be configured in some aspects to highlight the connection. In some implementations the instruction 530 may include a prediction accuracy estimate 536. For example, the prediction accuracy estimate 536 may include or correspond to the prediction accuracy estimate identified with respect to the predictions 522.

GUI 500 may include graphic elements for identifying communities based on how their performance is predicted to change (e.g., performance graphics). For example, GUI 500 may include a predicted increase graphic 540, a predicted no change graphic 542, and a predicted decrease graphic 544. These performance graphics may list sets of homes (e.g., communities), a predicted number of sales for each set of homes predicted for the current or a future interval of time, and an indication of how much the performance is predicted to change as compared to a previous interval of time. In some implementations, predictions of the number of homes to be sold in a community may not be as accurate due to high variations and noise resulting from comparatively low sales volume, and so the predicted number of homes may only be generated for regions or divisions of the home builder entity (e.g., as shown in prediction graphic 510). Even if predictions of the exact number of sales for the future interval of time are not made, a prediction of whether the sales will increase, decrease, or stay the same may still be made. The community names presented here (e.g., Fair Oaks Estates, Everdell Glen, etc.) are listed as illustrative examples of the kinds of names that may identify communities. In some aspects, these names may include or correspond to the communities illustrated in FIGS. 2 and 3 (e.g., C-1, C-2, C-n, etc.), or they may include or correspond to other communities of homes.

Predicted changes may be listed in the respective performance graphics as a predicted number of home sales greater than, equal to, or less than was achieved in a previous interval of time. Alternatively, the predicted changes may be listed as a percentage, or in some other way of indicating the change in predicted performance. According to aspects, the division of a set of homes into communities may be a breakdown of the total homes considered in developing the prediction graphic 510. A benefit of this kind of breakdown is that the performance and predicted performance of the home builder may be better understood on a per community basis, which may give insights into how a home builder may improve its performance for each community. Alternative configurations may include, for example breakdowns of a set of homes into predictions organized by regions, divisions, states, cities, school districts, home types, home plans, home age, home completion status, some other division as described herein or as may be known to those of skill in the art, or some combination thereof.

GUI 500 may include a plurality of selectable elements, including selectable element 550, selectable element 552, selectable element 554, a search bar 556, and a plurality of filters 558. In accordance with some aspects, any of the graphic elements of GUI 500 (e.g., prediction graphic 510, instruction 530, predicted increase graphic 540, predicted no change graphic 542, and/or predicted decrease graphic 544) may include or correspond to respective selectable elements. As non limiting illustrative examples, the graphic elements may be configured such that upon a user's selection of one or more of the graphic elements, the GUI 500 may change what is displayed, or cause a portion of the GUI to be highlighted, or display additional information related to the element selected. The selectable elements may enable better navigation of the GUI 500, or may be selected to modify how information in the GUI is arranged and/or presented. For example, upon selection of one or more of the plurality of filters 558, the GUI 500 may cause that insights (e.g., as presented by performance source indicator 534) related to the historical home demand data be adjusted to more closely align with the impact of the features selected.

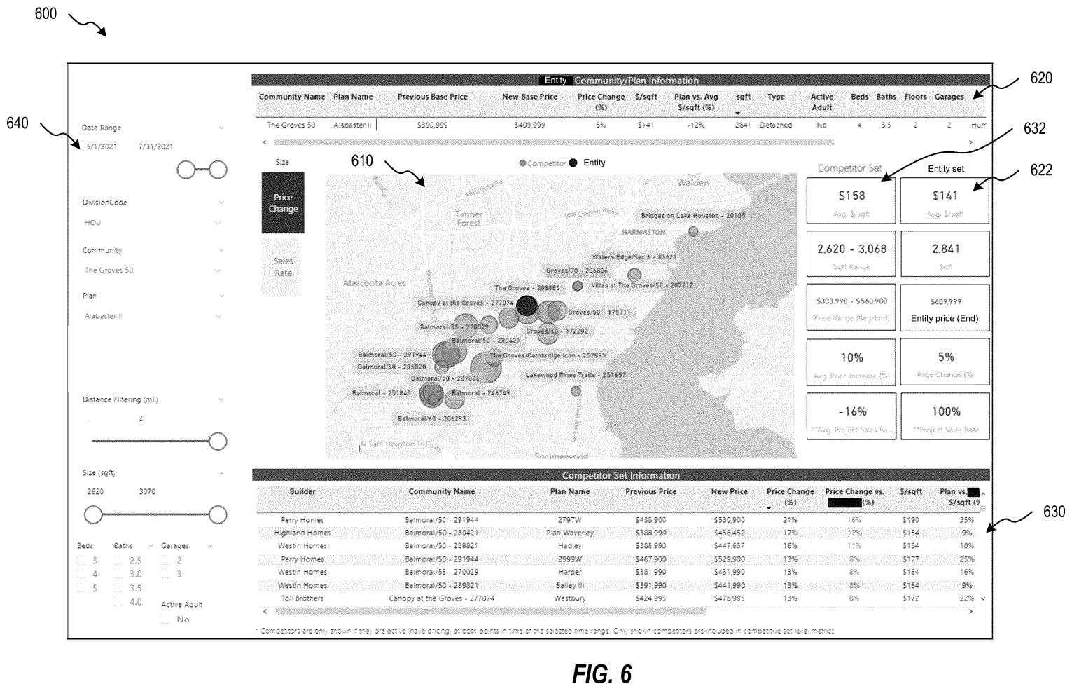

Reference is now made to FIG. 6, which illustrates a diagram of a GUI illustrating examples of market comparison and analysis performed by an intelligent home builder control and management system according to one or more aspects as a GUI 600. According to aspects, GUI 600 may be generated based on insights derived from one or more data sources across multiple contexts, and in real-time, or near real-time based on data related to the entity and its performance, data related to third parties (e.g., competitors), and/or external data. For example, as described above with reference to FIG. 1, the computing device 102 may generate GUI 600 via an I/O device 118. Alternatively, or additionally, the computing device 102 may cause GUI 600 to be generated at a client device 170. GUI 600 may be generated and/or populated based at least in part on data associated with the entity (e.g., home sales data 152 and/or home production data 154) received or derived from the entity data sources 150, data associated with a third party (e.g., third party data 158) received or derived from the third party data sources 156, external data 162 received or derived from the external data sources 160 and/or from data stored in memory 106 (e.g., home data 110, home status data 112, historic performance data 114, and/or historic pricing data 116). In an aspect, the data may be used to generate and/or populate at least portions of GUI 600 after the data is formatted and/or other intake operations are performed by the feature extraction engine 122. Alternatively, in some aspects, the data may be used directly to generate and/or populate portions of the GUI 600.

A difficulty that production home builders face is in determining how closely individual homes (or groups of homes, in the case of a community), produced by the home builder compare to other homes and communities in the market. Home builders may wish to better understand how homes compare to other homes in order to improve performance metrics related to planning, constructing, valuing, and/or selling homes in the market. For example, a home builder may use comparative data determine actionable steps that can be undertaken to improve performance, such as, for example, building more desirable features than competitors, adjusting availability of homes, adjusting prices to be more attractive to a customer than a competitor, or to improve marketing efforts relative to a competitor. GUI 600 may include various features useful in comparing homes and communities based on insights derived from diverse data sources. For example, GUI 600 may include a map view 610, an entity community data graphic 620, an entity comparison data graphic 622, a competitor community data graphic 630, a competitor comparison data graphic 632, and a plurality of selectable elements 640.

As shown in FIG. 6, a map view 610 may be dynamically generated by computing device 102 based on insights generated from data received from to show the locations of homes (e.g., home communities) associated with an entity relative to the locations of other homes (e.g., home communities) associated with one or more third parties and/or competitors. According to aspects, which homes are displayed in map view 610 may depend on parameters identified as features extracted from the data (e.g., by feature extraction engine 122), parameters predetermined for the map view 610 by system 100, parameters provided as inputs to the GUI by a user (e.g., inputs made through the selectable elements 640), or a combination thereof.

According to aspects, homes may render in map view 610 if they are determined to be comparable in at least one of the parameters and/or features. For example, home locations may render in the map view 610 if they are within a specified distance (e.g., within 2 miles) from a specified location (e.g., from a specified community associated with the home builder, from a point of interest in an area, or from a location specified by a user input to the GUI 600, such as by clicking a point on the map of the map view 610). Additionally, or alternatively, homes may render in the map view 610 if they are within a specified range of dimensions (e.g., within 20% of the square footage of a known home plan), within a specified range of a specified plan feature (e.g., within one of a number of bedrooms, a number of bathrooms, a number of garages, and/or a number of floors), within a specified range of prices (e.g., within 20% of a specified price value) or some combination thereof. The ranges and values listed above are provided as illustrative examples and are not provided as a limitation. Other values may be used in determining whether homes should be considered comparable, as may several other parameters. For example, homes may be compared correspondingly displayed based on parameters such as whether the home is in an active adult community (e.g., a community in which residents are above the age of 55), whether pets are allowed in the home or community, what school district the home is located in and how well the school district is ranked, how far the home is from an urban center, how far the home is from a point of interest (e.g., a sporting arena, a theatre, a lake, and so on), the zoning of the community (e.g., as single-family residences, as multi-family residences, and so on), or an additional parameter deemed relevant to the comparison.

According to aspects, data corresponding to the home(s) associated with the entity may be provided and/or summarized in entity community data graphic 620 and in entity comparison data graphic 622. For example, data corresponding to the home(s) associated with the entity may include the name of a community in which the home is located, the name of a home plan, the base price of the home, a change in the price of the home, a price per unit area (e.g., price per square foot), an indication of how the price of a home plan compares to a community average, an area of the home plan, a type of home the home plan describes (e.g., detached, single family, condominium, split level, etc.), an active adult parameter, a number of bedrooms, a number of bathrooms, a number of floors, a number of garages (e.g., the capacity of the garage), or a combination thereof. In the example of FIG. 6, a single plan is shown in entity community data graphic 620, but other home plans, locations, and/or communities may be included in entity community data graphic 620 in accordance with aspects of the disclosure.

Similarly, according to aspects, data corresponding to the home(s) associated with one or more competitors or other third parties may be provided and/or summarized in competitor community data graphic 630 and in competitor comparison data graphic 632. For example, data corresponding to the home(s) associated with one or more competitors or other third parties may include an identification of the one or more competitors or other third parties (e.g., a name of a third-party production home builder), a community name, a home plan name, a previous price of a home, a new price of a home, a price change corresponding to the previous price and the new price, a comparative price change as compared to homes associated with the entity, a price per unit area, a plan price per unit area as compared to homes associated with the entity, a type of home the home plan describes (e.g., detached, condominium, split level, etc.), an active adult parameter, a number of bedrooms, a number of bathrooms, a number of floors, a number of garages (e.g., the capacity of the garage), or a combination thereof.

The displays of GUI 600, including the homes displayed in map view 610 and the data displayed in entity community data graphic 620, entity comparison data graphic 622, competitor community data graphic 630 and competitor comparison data graphic 632 may be dynamically updated and/or adjusted as inputs are received from a user's selection of one or more of the selectable elements 640. According to additional or alternative aspects, the displays of GUI 600 may be dynamically updated and/or adjusted based on receiving updates to data from one or more data sources. For example, if a user decreased the range of distance filtering applied for GUI 600 then homes or communities that fell outside the new distance range may be removed from the display. Similarly, if a user increased the range of distance filtering, homes that are located within the new range may be added to the display. Similar adjustments may be made on adjustments in user input or data received related to home plan information, price ranges, number of available homes, or some other parameter as discussed above or as would be known to one of sill in the art. Thus, changes to the parameters may cause the computing device 102 to dynamically update the GUI 600 as data is updated or as inputs to the GUI 600 are received.

According to aspects, the GUI 600 may present at least a portion of the data in such a way that comparisons between homes associated with the entity and homes associated with one or more third parties may be quickly made. For example, entity comparison data graphic 622 may be displayed with competitor comparison data graphic 632 in a side-by-side portion of GUI 600. Alternatively, or additionally, entity comparison data graphic 622 and competitor comparison data graphic 632 may be displayed as a comparative graphic display, such as, for example, a histogram, line graph, scatterplot, bar graph, or other comparative chart. Such a chart may be useful for identifying and displaying trends as they relate to the comparison between the entity and a third party competitor. A view of GUI 600 including such graphical comparative information may be displayed dynamically in response to an input to the GUI 600, such as, for example, through a selection of a selectable element 640 or by selection of either of the entity comparison data graphic 622 and competitor comparison data graphic 632. According to aspects, a user selection of a home, plan, and/or community from map view 610, entity community data graphic 620, and/or competitor community data graphic 630 may cause the selected home/plan/community to be displayed in the comparative view shown by entity comparison data graphic 622 and competitor comparison data graphic 632. Similarly, user selection of a parameter value (e.g., price change, $/sqft, etc.) from entity community data graphic 620 and/or competitor community data graphic 630 may cause the selected parameter to receive focus in the comparative view shown by entity comparison data graphic 622 and competitor comparison data graphic 632. In an aspect, the side-by-side view shown in FIG. 6 may be toggled with an alternative comparative graphic display in response to user input.

According to some aspects, information displayed by entity comparison data graphic 622 and competitor comparison data graphic 632 may be based on a determination of the most comparable features between a home or community associated with the home builder entity and a home or community associated with the third party competitor. For example, features that may be most relevant to the price of a given home in comparison to the other homes on the market may be displayed more prominently than features which are more incidental to the comparison. In some aspects, the comparisons may be ranked by relevance to the home comparison, or by the impact that a feature has on the comparison. The ranking may be reflected in the order in which the features are displayed in GUI 600. In some aspects, such a determination may be made and/or transmitted by the recommendation module 138 of FIG. 1.

The comparative analysis described above may have several advantages, including dynamic, real-time updates based on data received. Systems and methods implementing such a data-focused analysis may enable quick comparisons to be made between features of homes to determine, for example, how homes may be comparatively and competitively priced. It may also enable rapid reaction to changes in the market or newly updated data related to a home builder's supply of homes, such that a home builder may be able to quickly adjust performance efforts in light of insights produced from the data.

Tools enabling home builders to react quickly to the market can be highly valuable. Also valuable are tools that are powered by more robust models to empower more forward-thinking, predictive, and data-driven decision making. According to aspects, a machine learning model may be used to identify comparable homes based on multiple data inputs or parameters. According to some aspects, the machine learning model may include an unsupervised machine learning clustering algorithm specifically trained to identify comparable homes and generate predictions. For example, reference is again made to FIG. 1, in which computing device 102 may include a classification engine 130. Classification engine may be configured to receive inputs of features or feature vectors identified and extracted from the data by feature extraction engine 122. Classification engine 130 may include or correspond to an ML model 132. In some implementations, the ML model 132 may be an unsupervised ML model. Alternatively, the ML model 132 may be a supervised ML model.

ML model 132 may be specifically trained to classify a home, which may be represented as a vector of features, to one or more clusters in a multidimensional feature space. For example, ML model 132 may be trained by classification training engine to create a multidimensional feature space from a dataset including vector representations for each of a plurality of homes, including homes associated with a home builder that owns or controls the computing device 102 and homes associated with parties other than the home builder that owns or controls the computing device 102. The vector representations of homes may be generated as outputs of the feature extraction engine 122. Homes (e.g., feature vectors) represented in the multidimensional feature space may be clustered together based on similarity to one another. For example, similarity may be determined by a distance measurement between respective data points (e.g., features) in the multidimensional feature space, such that the closer data points are to each other within a multidimensional space, the more similar they are likely to be. Different distance measurements may be used to determine similarity, nonlimiting examples of which include a Euclidean distance, a Manhattan distance, and/or a Hamming distance (e.g., an overlap metric). According to aspects, the ML model 132 may be trained entirely on local data. For example, the trained ML Model may be trained on data from a single geographic area, such as a city, a metropolitan area, a county, or another regional division. Training ML model 132 based on local data may mean that the model may be extraordinarily fast to train and to use in generating predictions. For example, in some implementations, the model may be trained in less than 3 minutes.

The ML model 132 may be configured to classify a given home, also referred to as a target home (represented as a feature vector) relative to other homes (also represented as feature vectors in a multidimensional space). When a feature vector representing a given home is provided to the ML model 132, it may be classified as belonging to a cluster based on its respective similarity to datapoints already known by the ML Model 132. Homes that are identified as being comparable to the given home may be identified and presented, along with a respective set of data or features for each of the comparable homes.

According to aspects, an exemplary algorithm that ML model 132 may employ in performing clustering of features within the multidimensional feature space is a K-nearest neighbors (KNN) algorithm. A KNN algorithm is an ML algorithm that can be used for both classification and regression applications. A KNN algorithm as applied to aspects of this disclosure, may compare a given data point (e.g., a feature vector representing a given home) to other points mapped and clustered in a multidimensional feature space. For example, the KNN algorithm may calculate the distance (e.g., a Euclidean distance) between the given data point and each other data point in the multidimensional feature space. The KNN algorithm may determine, based on a sort of the distances calculated, which data points the given data point is closest to. Based on a majority vote of the closest k neighbors, the given data point may be classified (e.g., clustered) as belonging with the cluster of data points that it is most similar to. For example, for k=3, the 3 nearest data points would be determined, and a classification of a majority of the 3 nearest data points would determine the classification of the given data point. Additionally, or alternatively, each of the k nearest data points homes to the given home may be provided as outputs from the KNN model. Alternatively, more than k homes may be output as comparable homes. For example, if the KNN model determines that the given home is most similar

The value of k may be determined in order to prevent both overfitting and underfitting. For example, the best value of k may be determined by using cross validation or a learning curve. Alternatively, or additionally, a k value may be determined to provide transparency and enable a clear evaluation of classification determinations. For example, evaluation of classifications and/or may be provided by human reviewers and stakeholders.

According to some aspects, The ML model 132 may also be trained to compute a weighted average of home prices for the homes determined to be most comparable to a given home (also referred to as a target home). For example, the ML model 132 may be configured to determine how much weight to assign to the price of each comparable home based on how similar the comparable home is to the given home. According to aspects using a KNN algorithm, if k=3, the ML model 132 may compute the average price of the 3 most comparable homes weighted based on their respective Euclidian distances within the multidimensional feature space from the given home. For example, the Euclidean distances themselves may be applied as weights to the home prices, or they may be modified (e.g., normalized or otherwise transformed) before being applied as weights to the home prices. A weighted average may be calculated from the weighted home prices. In some implementations, a price of the given home may be set at the weighted average price.

According to some aspects, classification engine 130 may include one or more additional ML models configured to improve the pricing accuracy of the system 100. For example, classification engine 130 may include a comp-selection model (not shown) configured to identify and select a pool of potentially comparable homes. According to aspects, the comp-selection model may include rule-based and/or iterative filtering to determine a pool of comparable homes. For example, the comp-selection model may implement rules based on the number of homes in a particular geography or having particular features, such as any of the features and data categories identified throughout this disclosure. According to aspects, the comp-selection model may be backed by reinforcement learning. Alternatively, or additionally, classification engine 130 may include a deep neural net (DNN) configured to capture relationships between home features of the given home and the most comparable other homes. In some instances, the DNN may identify relationships and/or patterns between data that might be unseen by human analysts. For example, a DNN may be able to identify patterns based on high-frequency data or slight shifts in data that would be imperceptible to a human observer.

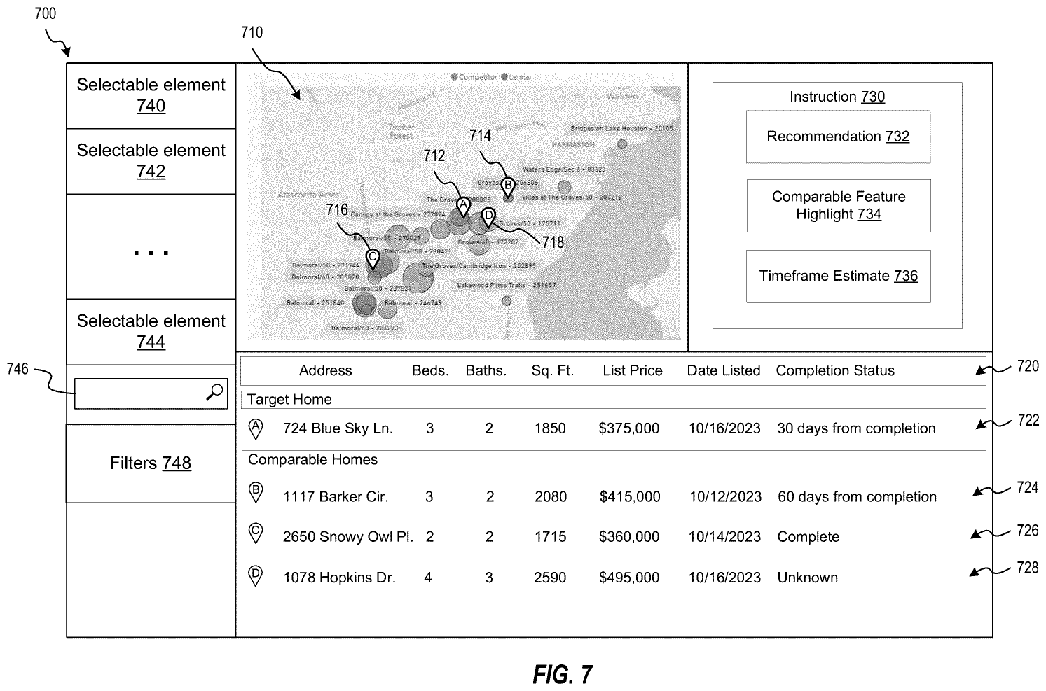

The outputs of the classification engine 130 may be output to a user. For example, reference is now made to FIG. 7, in which a diagram of a GUI illustrating examples of intelligent market comparison and analysis performed by an intelligent home builder control and management system according to one or more aspects is shown as GUI 700. GUI 700 illustrates ways that an exemplary GUI may be populated, at least in part, based on the output of classification engine 130. For example, GUI 700 may illustrate a comparison between a target home (e.g., a home to be sold by a home builder entity) and comparable homes in the market and may provide instructions to the home builder to optimize its performance relative to the target home. According to some aspects, GUI 700 may provide an instruction for setting the price of the target home.

GUI 700 may include a map view 710. Map view 710 may illustrate the location of the target home at location 712, as well as the locations of comparable homes at locations 714, 716, and 718. The comparable homes may be identified from a larger plurality of homes by the classification engine 130. Features of the target home and the comparable homes may be output to the GUI 700 in a home data comparison display 720. For example, data corresponding to the target home may be displayed at 722. Data corresponding to the comparable homes may be displayed at 724, 726, and 728. In this example, the three most comparable homes are identified by way of an illustration and not a limitation. Other comparable homes may be identified and/or displayed to the GUI 700. Note that in this example, the home C at location 716 is further away from the target home A at location 712 in physical distance than the home B at location 714 or the home D at location 718, but it was identified as more comparable to target home A than home D is to target home A is because it is closer in its parameters. For example, home C has the same number of bathrooms, 1 fewer bedroom, and is within 20% of the area of home A, while home D has 1 more bedroom and bathroom, and is 25% larger in area than home A. These example values are provided by way of illustration and not as a limitation, and other values may be identified and/or weighted to identify the most comparable homes in a dataset for a given target home. For example the completion status, the date listed, the list price, or some other feature such as have been described herein, may also be given weight in determining comparable homes.

GUI 700 may include an instruction 730. Instruction 730 may include a recommendation 732. Recommendation 732 may instruct a home builder to undertake an actionable step. For example, recommendation 732 may include an instruction to raise or lower a price of the target home, an instruction to make the price of the target home equal to a weighted average of the prices of the comparable homes, an instruction to adjust an advertising effort for the target home, an instruction to increase or decrease a construction rate for the target home, a report of a recommended target price, a report of the prices of the one or more related homes, a report of a range of prices about the target price, or a combination thereof. Instruction 730 may include a comparable feature highlight 734. For example, comparable feature highlight 734 may illustrate features identified by the classification engine 130 as making one home more comparable to the target home than others, but which may be difficult to convey numerically—or which may appear in a pattern that human may not notice. According to aspects, instruction 730 may include a time frame estimate 736. Time frame estimate 736 may provide data related to the availability of a given home based on its completion status. Alternatively, time frame estimate 736 may provide an estimate for how long the comparison might be valid, or for how long the comparable home may be on the market at its current price, or for how long the target home might be expected to be on market before selling. These features of the instruction 730 may be based on the various data received by the computing device, classifications made by classification engine 130, predictions made by prediction engine 134, recommendations made by recommendation module 138, or some combination thereof.

GUI 700 may include a plurality of selectable elements, including selectable element 740, selectable element 742, selectable element 744, search bar 746, and filters 748. Much like the selectable elements described with respect to the other GUIs described throughout the disclosure, these selectable elements may enable a user to interact with, provide input to, and modify the GUI 700 and/or the underlying data by which the GUI 700 is populated and generated. For example, the selectable elements may enable a user to select a target home (or a different target home than was already selected). In some implementations, selecting a target home may cause the computing device 102 and the classification engine 130 to determine the most comparable homes to the target home and modify the GUI 700 accordingly. According to aspects, the selectable elements may enable a user to search for and/or filter homes by particular features, or to provide new weights or priorities to the classification engine 130. For example, selections may cause the classification engine 130 to filter out homes based on home type, or to account for features like a school district, local geography, active adult communities, and so on. In some implementations, such searching or filtering may cause the classification engine 130 to produce a new set of comparable homes based on the new weights and priorities. This may provide insight into the comparable homes and why the classification engine 130 determined them comparable. Data derived from this process may be included in the instruction 730.

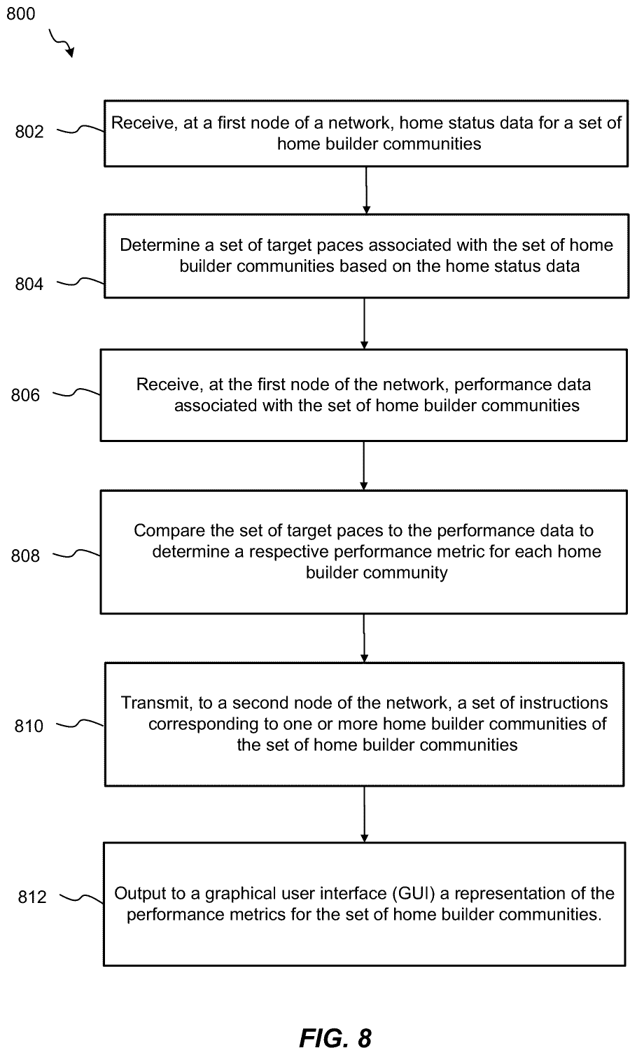

Reference is now made to FIG. 8, in which a flow diagram illustrating an example process that supports dynamic performance pacing for home builders according to one or more aspects is shown as a process 800. Operations of process 800 may be performed by a computing device, such as computing device 102 described above with reference to FIGS. 1-7. For example, example operations (also referred to as “blocks”) of process 800 may enable computing device 102 to support dynamic pacing operations for a home builder, including determining a pace for the home builder and providing instructions based on the pace.

In block 802, the computing device 102 receives, at a first node of a network, home status data for a set of home builder communities. For example, the home status data may include or correspond to data received from one or more data sources, such as entity data source 150 as illustrated in FIG. 1. In some implementations, each of the home builder communities may include a respective set of homes. In some implementations, the home status data may include at least a completion status for each home of the set of home builder communities. For example, the completion status of each home may include or correspond to one of the competition statuses displayed by inventory representation 240 of FIG. 2. In some implementations, the home status data may include a set of historical performance data for the home builder communities and/or a target metric. For example, the historical performance data and/or the target metric may include or correspond to the home data 110, the home status data 112, the historic performance data 114, the home sales data 152, or the home production data 154 of FIG. 1, or the statistical data 250 of FIG. 2.

In block 804, the computing device 102 may determine a set of target paces associated with the set of home builder communities based on the home status data. For example, the target paces may include or correspond to the target paces 214, 224, and 234 of FIG. 2. In some implementations, each target pace of the set of target paces may be associated with the sale of homes within a respective home builder community during a selected time period.

In block 806, the computing device 102 may receive, at the first node of the network, performance data associated with the set of home builder communities. In some implementations, the performance data may indicate historic sales associated with the set of home builder communities. For example, the performance data may include or correspond to the home data 110, the historic performance data 114, the historic pricing data 116, the home sales data 152, or the home production data 154 of FIG. 1, or the statistical data 250 of FIG. 2. In some implementations, the performance data may include or correspond to performance as measured, averaged, and/or collected over a period of time. For example, the performance data may include or correspond to historical paces 212, 222, and 232 of FIG. 2, which are shown as an average pace over a four week period. Other time frames for performance data, either longer or shorter than the four weeks shown in FIG. 2, may also be implemented.

In block 808, the computing device 102 may compare the set of target paces to the performance data to determine a respective performance metric for each home builder community. In some implementations, the performance metric may be related to the target paces, such as, for example, the categorization of the home builder community based on how it measures up to the target pace, as shown in FIG. 2.

In block 810, the computing device may transmit, to a second node of the network, a set of instructions corresponding to one or more home builder communities of the set of home builder communities. In some implementations, the set of instructions may be based on one or more performance metrics associated with the one or more home builder communities. For example, in some implementations, the instructions may be based on a pace of the home builder community, and/or may provide a direction to a home builder to undertake one or more actions to achieve the pace. Such actions may include, as non-limiting examples, adjusting a price for a home in the first plurality of homes, adjusting an advertising effort, modifying a performance metric, or a combination thereof. In some implementations, the set of instructions may include a recommendation for selling a subset of the set of homes first (e.g., at a prioritized pace or with greater urgency). For example, the subset may include or correspond to one or more homes that have a completion status of fully built (e.g. construction complete) or within a second building phase, as illustrated by inventory representation 240 of FIG. 2. In some exemplary implementations, the second building phase may include or correspond to homes that are closer to completion than homes within a first building phase (e.g., a second building phase is illustrated by the homes 30 days or less from completion in inventory representation 240, while the first building phase may include either or both of the homes 61+ or 31-60 days from completion).

In block 812, the computing device 810 may output to a graphical user interface (GUI) a representation of the performance metrics for the set of home builder communities. For example, the GUI may include or correspond to GUI 200 of FIG. 2. In some implementations, aspects of GUI 200 may include aspects disclosed with respect to GUI 300 of FIG. 3, GUI 500 of FIG. 5, GUI 600 of FIG. 6, and/or GUI 700 of FIG. 7. That is, the GUIs illustrated in this disclosure are intended as illustrative examples, and aspects disclosed with respect to one of the GUIs may be incorporated into one or more other GUIs.

According to aspects, the representation of the performance metric for the set of home builder communities indicates whether a first home builder community of the set of home builder communities is ahead of a target pace associated with the first home builder community, meeting the target pace, or behind the target pace. For example, the GUI 200 illustrates communities ahead of a respective target pace at graphical representation 210, communities meeting a respective target pace at graphical representation 220, and communities behind a respective target pace at graphical representation 230. According to additional aspects, being ahead of the target pace may include having a historical performance metric more than 0.5 sales above the target pace, meeting the target pace may include having a historical performance metric within 0.5 sales of the target pace, and being behind the target pace may include having a historical performance metric more than 0.5 sales below than the target pace.

According to aspects, the completion status for each home of the set of home builder communities may indicate that a given home is scheduled to be built, within a first building phase, within a second building phase, or fully built. For example, the completion status of homes may correspond to the home production data 154 of FIG. 1 and/or may be displayed in GUI 200 as inventory representation 240.

According to aspects, the historical performance metric may include an average historical performance over a period of time. For example, the average historical performance over the period of time may include or correspond to the historical performance.

According to aspects, the process 800 may further include receiving a user input that includes the selected time period. For example, a user may manipulate elements of the GUI 200 or provide input for selecting a time period. For example, this may include or correspond to a selection of one or more of the selectable elements 260.

According to aspects, the process 800 may further include performing one or more additional steps. For example, the process 800 may further include tracking the performance data for a home builder community and dynamically updating the respective target pace and performance metric for the home builder community based on the tracking. As an additional or alternative example, the process 800 may further include receiving additional home status data for new homes in a home builder community and dynamically updating the target pace and performance metric based on the additional home status data. As an additional or alternative example, the process 800 may further include receiving the home status data from a client device, a proprietary feed, a public data source, a first data source, or a combination thereof. As an additional or alternative example, the process 800 may further include receiving the performance data from a client device, a public performance data source or feed; a second data source, or a combination thereof. As an additional or alternative example, the process 800 may further include outputting to the GUI a representation of the home status data.

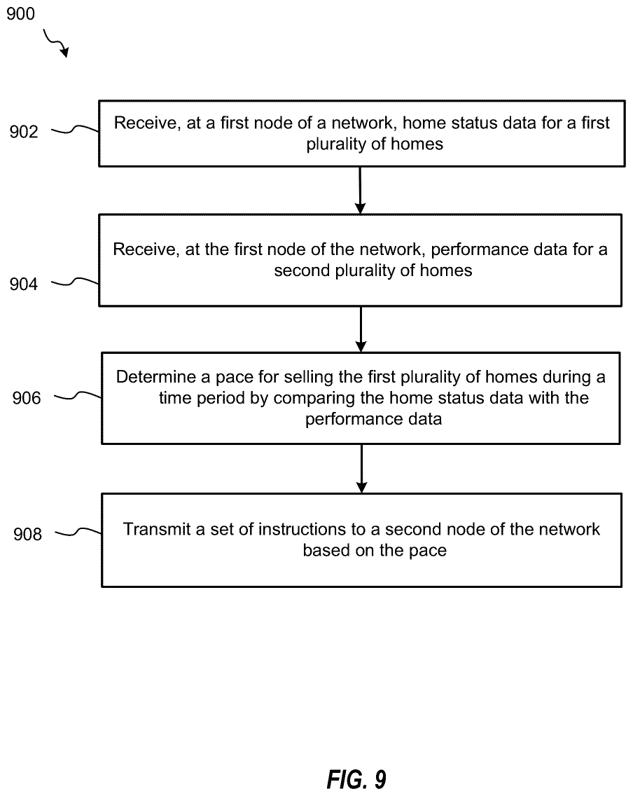

Reference is now made to FIG. 9, which is a flow diagram illustrating an example process 900 that supports dynamic performance pacing for home builders according to one or more aspects. Operations of process 900 may be performed by a computing device, such as computing device 102 described above with reference to FIGS. 1-7. For example, example operations (also referred to as “blocks”) of process 900 may enable computing device 102 to support dynamic pacing operations for a home builder, including determining a performance pace for the home builder and providing instructions based on the performance pace.

In block 902, the computing device 102 may receive, at a first node of a network, home status data for a first plurality of homes. According to aspects, the home status data may include at least a completion status for each home of the first plurality of homes and a target metric for the first plurality of homes. For example, the home status data may include or correspond to data received from one or more data sources, such as entity data source 150 as illustrated in FIG. 1. In some implementations, each of the home builder communities may include a respective set of homes. In some implementations, the home status data may include at least a completion status for each home of the set of home builder communities. For example, the completion status of each home may include or correspond to one of the competition statuses displayed by graphic representation (e.g., an inventory representation 356) of FIG. 3. In some implementations, the home status data may include a set of historical performance data for the home builder communities and/or a target metric. For example, the historical performance data and/or the target metric may include or correspond to the home data 110, the home status data 112, the historic performance data 114, the home sales data 152, or the home production data 154 of FIG. 1. According to aspects, the first plurality of homes may include or correspond to homes in production, under construction, and/or available for sale by a home builder. For example, the first plurality of homes may include or correspond to homes represented by graphic representation 356 or by graphical tool 358.

In block 904, the computing device 102 may receive, at the first node of the network, performance data for a second plurality of homes. According to aspects, the performance data may indicate one or more historic performance values in the second plurality of homes. According to aspects, the second plurality of homes may include or correspond to homes already sold by the home builder. For example, the performance data for the second plurality of homes may include or correspond to the historic performance data 114, the home sales data 152, or the home production data 154 of FIG. 1.

In block 906, the computing device 102 may determine a pace for performing transactions (e.g., including selling) at least a portion of the first plurality of homes during a time period by comparing the home status data with the performance data. According to aspects, the pace may include, for a plurality of increments of the time period, a number of homes of the set of homes to be sold during a respective increment. For example, the time period may include a month, a quarter, a year, a production cycle, or some other period of time. An increment (also referred to as an interval or a division) of the period of time may include a day, a week, a portion of the production cycle, or some other interval dividing the period of time. For example, the increments may be periodic measurements of time, and may be of equal length in time. The period of time may include or correspond to the collective time intervals illustrated by pacing graphic 310 and/or completion status graphic 330 of FIG. 3. The increments of time may include or correspond to the increments 312-320 of FIG. 3. According to aspects, the pace may be determined to prevent a change in the number of homes to be sold during any two consecutive increments of the plurality of increments from exceeding a first threshold. For example, the first threshold may be configured to prevent more or fewer transactions from being performed than may be sustainable for the home builder.

In block 908, the computing device 102 may transmit a set of instructions to a second node of the network. The set of instructions may include or correspond to Instruction 360 of FIG. 3. According to aspects, the set of instructions may be based on the pace. For example, the set of instructions may instruct a home builder to undertake one or more actions to achieve the pace. In some implementations, the one or more actions may include adjusting a price for a home in the first plurality of homes, adjusting an advertising effort, modifying a performance metric, or a combination thereof.

According to aspects, the first threshold may be determined dynamically based on the home status data and the performance data. For example, the first threshold may be determined in real-time or near real-time as updates to the data are received. In an aspect, the first threshold may be preprogrammed (e.g., as a parameter to the method 900). Additionally, or alternatively, the first threshold may be determined by a user (e.g., through an input to GUI 300). Additionally or alternatively, the threshold may be based on historical data. For example, if a pace is determined to require a home builder community to sell eight homes in an upcoming week, but the home builder community has historically never sold more than three homes in a given week, the threshold may constrain the pace into a more realistic pace (e.g., at three homes, or, possibly to promote gradual increases, four homes).

According to aspects, the completion status for each home of the first plurality of homes may indicate that a respective home is scheduled to be built, within a first building phase, within a second building phase, or fully built. For example, this may include or correspond to homes illustrated by graphic representation 356 for showing homes based on completion status. According to aspects, the set of instructions may include a recommendation for selling a subset of the set of homes first (e.g., at a prioritized pace, before other homes in the set of homes, or with greater urgency). For example, the subset may include or correspond to one or more homes that have a completion status of fully built or within a second building phase. In a further example, the second building phase may include or correspond to homes that are closer to completion than homes within the first building phase.

According to aspects, the pace may be determined by applying a modified geometric series to a number of homes to be sold during the plurality of increments of the selected time period. The pace may further be determined by allocating a portion of the homes to be sold from a present increment of the plurality of increments of time to one or more future increments of time based on the modified geometric series.

According to aspects, the pace may be determined by applying a beta distribution to the number of homes to be sold during the plurality of increments of the selected time period, wherein the beta distribution is configured to provide a lower pace for each successive increment of the selected time period. The pace may further be determined by allocating a portion of the homes to be sold from one or more future increment of the plurality of increments of time to a present increment of time based on the beta distribution.

According to aspects, determining the pace may further include determining that the pace for a first increment of the selected time period is higher than a second threshold, determining that the pace for a second increment of the selected time period is lower than the second threshold, and modifying the pace for the second increment by applying at least a portion of the pace from the first increment to the second increment. For example, the portion of the pace from the first increment may be less than or equal to the difference between the second threshold and the pace for the second increment. This process may include or correspond to the reallocation of paced homes from 326 to 328 as illustrated in FIG. 3 and described herein.

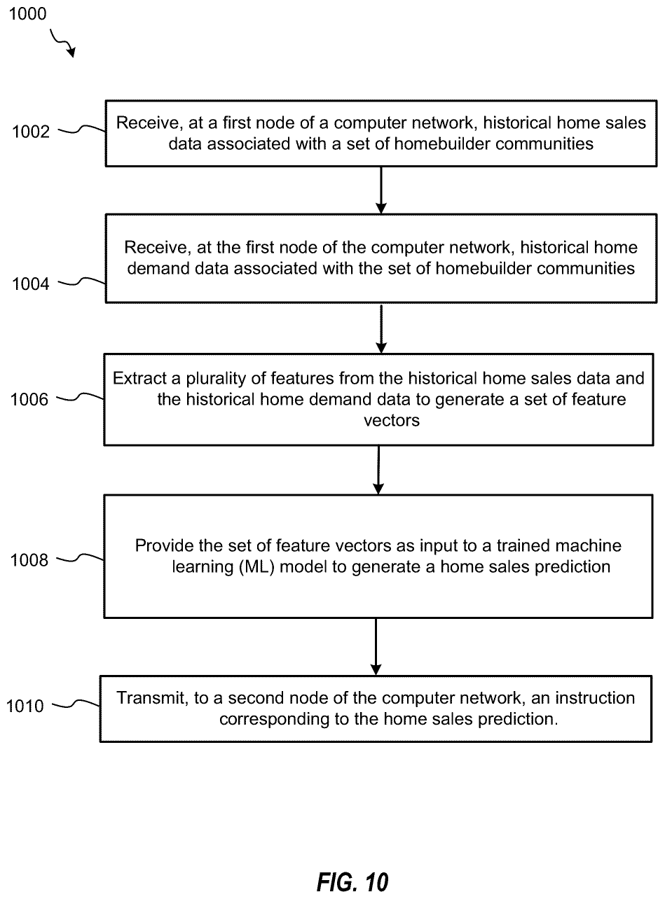

Reference is now made to FIG. 10, which is a flow diagram illustrating an example process 1000 that supports home builder data tracking and performance prediction according to one or more aspects. Operations of process 1000 may be performed by a computing device, such as computing device 102 described above with reference to FIGS. 1-7. For example, example operations (also referred to as “blocks”) of process 1000 may enable computing device 102 to predict the performance of a home builder. According to some aspects, computing device 102 may be configured to use a machine learning model, such as prediction engine 124 of FIG. 1, to predict a home builder's performance for a future period of time based on historical data. For example, process 1000 may enable machine learning-based market forecasting for home builders.

In block 1002, computing device 102 may receive, at a first node of a computer network, historical home sales data associated with a set of homebuilder communities. For example, the historical home sales data may include or correspond to historic performance data 114, historic pricing data 116, and/or home sales data 152 of FIG. 1.

In block 1004, computing device 102 may receive, at the first node of the computer network, historical home demand data associated with the set of homebuilder communities. Non-limiting examples of historical demand data may include leads data, customer inquiry data, website visit data, data associated with appointments made with the entity (e.g., home showings), data associated with mortgage buy-down rates used by the entity, historical sales data associated with one or more third parties (to the extent that it is available or known), external data such as a federal mortgage interest rate, data from a third party data source, data from a source of streaming data, data identified by web crawlers, data from a proprietary data source, publicly available data, data acquired using an application programming interface (API), or some combination thereof. According to aspects, the historical home demand data may include or correspond, at least in part, to home data 110, home status data 112, historic performance data 114, historic pricing data 116, home sales data 152, home production data 154, third party data 158, and/or external data 162.

In block 1006, computing device 102 may extract a plurality of features from the historical home sales data and the historical home demand data to generate a set of feature vectors. For example, the feature extraction engine 122 may be configured to perform the extracting operation(s) as described herein. According to aspects, the set of feature vectors may include a numerical representation of the plurality of features extracted from the historical home sales data and the historical home demand data.

In block 1008, the computing device 102 may provide the set of feature vectors as input to a trained machine learning (ML) model to generate a home sales prediction. For example, the set of feature vectors may include or correspond to the output of the feature extraction engine 122 of FIG. 1 and/or the input 410 of FIG. 4. The trained ML model may include or correspond to the prediction engine 124 of FIG. 1 and/or the ML model 400 of FIG. 4 (e.g., the ML forecasting model 420). According to aspects, the trained ML model may include a plurality of initial layers, a first final layer, and a second final layer. For example, the plurality of initial layers may include or correspond to first initial layer 422, second initial layer 424, and third initial layer 426, the first final layer may include or correspond to first output layer 430, and the second final layer may include or correspond to second output layer 440. According to aspects, the home sales prediction may include a predicted number of home sales for a time period. For example, the home sales prediction may include or correspond to sales prediction 450 of FIG. 4 and/or the predicted home sales illustrated by prediction graphic 510 of FIG. 5 (e.g., predictions 522 over future time period 520). According to aspects, the predicted number of sales may be for a geographic area including multiple communities, such as, for example, metropolitan area, a state, and/or a region or a division associated with a home builder entity. According to additional or alternative aspects, the home sales prediction may include a predicted change in home sales from a previous time period to the time period. For example, the home sales prediction may include or correspond to predicted performance change 460 of FIG. 4 and/or the predicted change in home sales illustrated by predicted increase graphic 540, predicted no change graphic 542, and/or predicted decrease graphic 544 of FIG. 5. According to aspects, the predicted change in home sales may be determined for a community or a subdivision of the home builder entity.

In block 1010 the computing device 102 may transmit, to a second node of the computer network, an instruction corresponding to the home sales prediction. The instruction may include or correspond to instruction 530 as discussed herein. For example, the instruction may include or correspond to an instruction to raise or lower the price of a home, an instruction to increase or decrease a construction rate for a home, an instruction to acquire additional property lots, a report of the predicted number of sales, a report of the predicted change in the number of homes, or a combination thereof.

According to aspects, the predicted change may include an increase in home sales, a decrease in home sales, or no change in home sales. For example, the predicted change may include or correspond to the changes in home sales illustrated by predicted increase graphic 540, predicted no change graphic 542, and/or predicted decrease graphic 544 of FIG. 5.

According to aspects, the trained ML model may include or correspond to one or more neural networks.

According to aspects, the plurality of initial layers may include an input layer, a long short-term memory (LSTM) layer, and a dropout layer. For example, the first initial layer 422 may be an input layer, the second initial layer 424 may be an LSTM layer, and the third initial layer 426 may be a dropout layer as described herein.

According to aspects, the first final layer may be configured to output predicted numbers of home sales. In some additional aspects, the first final layer may be configured to optimize a mean squared error (MSE) loss function. For example, the MSE loss function may include or correspond to MSE loss function 432 of FIG. 4.

According to aspects, the second final layer may be configured to output predicted changes in home sales. In some aspects, the second final layer may be configured to perform a softmax activation function to output the predicted changes in home sales as one or more probability values associated with particular changes in home sales. For example, the softmax activation function may include or correspond to softmax activation function 442 of FIG. 4. Additionally or alternatively, according to aspects, the second final layer may include a dense layer configured to determine a first probability that the predicted changes in home sales for the time period is an increase in home sales from the previous time period, a second probability that the predicted changes in home sales for the time period is a decrease in homes sales from the previous time period, and a third probability that the predicted changes in home sales for the time period do not change from the previous time period. According to some additional aspects, the second final layer may be further configured to output a highest probability of the first probability, the second probability, and the third probability.

According to aspects, the trained ML model may be configured to provide outputs of the plurality of initial layers as inputs to the first final layer and as inputs to the second final layer.

According to aspects, the historical home demand data may include leads data, customer inquiry data, website visit data, data from a third party data source, data from a source of streaming data, data identified by web crawlers, data from a proprietary data source, publicly available data, data acquired using an application programming interface (API), or a combination thereof.

According to aspects, the processor (e.g., the one or more processors 104) may be configured to perform steps for training the trained ML model. According to aspects, the steps may include training the trained machine learning model in a first phase and a second phase. For example, the first phase may include an early stopping phase configured to prevent overfitting and/or to prevent the training from exceeding a target threshold. As an additional example, the second phase may include training the trained machine learning model on an entirety of a dataset for a determined number of epochs and at a predetermined learning rate.

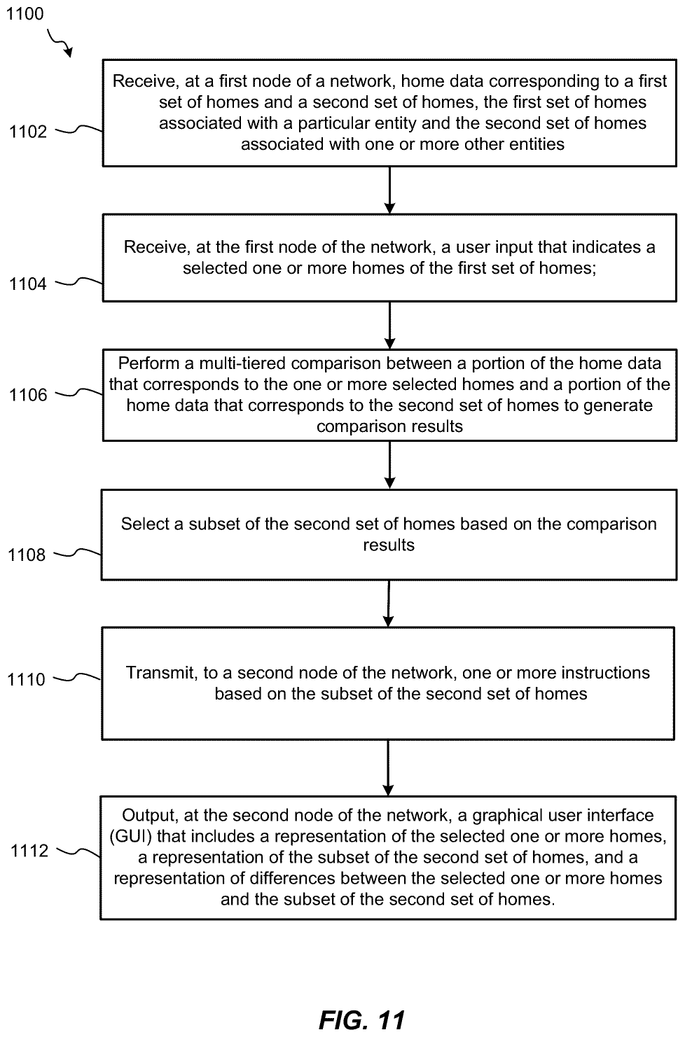

Reference is now made to FIG. 11, which is a flow diagram illustrating an example method 1100 that supports market comparison and analysis for home builders according to one or more aspects. Operations of method 1100 may be performed by a computing device, such as computing device 102 described above with reference to FIGS. 1-7. For example, example operations (also referred to as “blocks”) of method 1100 may enable computing device 102 to identify and categorize comparisons between homes associated with a home builder and homes associated with one or more third parties.

According to aspects, method 1100 may perform intelligent competitor set identification and/or comparison for home builder communities. In block 1102 of method 1100, the computing device 102 may receive, at a first node of a network, home data corresponding to a first set of homes and a second set of homes. According to aspects, the first set of homes may be associated with a particular entity (e.g., a home builder) and the second set of homes may be associated with one or more other entities (e.g., another home builder or another seller of homes). The home data may include or correspond to home data 110, home sales data 152, home production data 154, third party data 158, external data 162, home data received from some other source not shown in FIG. 1, and/or some combination thereof. According to some aspects, the second set of homes may include or correspond to independently offered homes being sold in the market. According to aspects, the home data may include or correspond to a respective plurality of parameter values. The respective plurality of parameter values may correspond to each home of the first set of homes and the second set of homes. For example, according to aspects, the plurality of parameter values may include a location of the corresponding home, a price range of the corresponding home, dimensions of a home plan of the corresponding home, and a layout of the home plan of the corresponding home. The parameter values may include or correspond to values such as those illustrated by entity community data graphic 620 and/or competitor community data graphic 630 of FIG. 6, but other parameters not explicitly shown by these examples may also be included.

In block 1104, the computing device 102 may receive, at the first node of the network, a user input that indicates a selected one or more homes of the first set of homes. For example, the user input may be received through one or more of the I/O Devices 118, or from a client device 170 over the network 140 and through the communication interface(s) 120. According to aspects, the user input may be input using selectable element a GUI, such as selectable elements 640 (or built into other elements of GUI 600) in FIG. 6.

In block 1106, the computing device 102 may perform a multi-tiered comparison between a portion of the home data that corresponds to the one or more selected homes and a portion of the home data that corresponds to the second set of homes to generate comparison results. In block 1108, the computing device 102 may select a subset of the second set of homes based on the comparison results. For example, the comparison results may correspond, at least in part, to homes illustrated by either or both of competitor community data graphic 630 and competitor comparison data graphic 632. In some implementations, homes from the second set of homes may be excluded from the subset of the second set of homes based on the comparison results.

In block 1110, the computing device 102 may transmit, to a second node of the network, one or more instructions based on the subset of the second set of homes. According to aspects, the second node of the network may include or correspond to another portion of the computing device 102, such as a location in memory 106, or the second node of the network may include or correspond to one or more of the data sources 150, 156, and/or 160, or the second node of the network may include or correspond to the client device 170. According to aspects, the instructions may recommend an actionable step to the home builder. The instructions may be based on insights derived from the several data sources across multiple contexts and in real-time, or near real-time, and in some implementations actions may be automatically performed. The instructions may include, as non-limiting examples, generating points of comparison determined to be particularly relevant to a particular community (e.g., predictive of value), instructing a home builder to change a parameter (e.g., a price, a goal sale time frame, a pace, an availability date, a lot for which a plan is determined, a completion timeframe, and the like) for a home, a home plan, or a community, and/or generating a report based on the comparison of the subset of homes. According to some aspects, the instructions may be generated by recommendation module 138.

In block 1112, the computing device 102 may output, at the second node of the network, a graphical user interface (GUI) that includes a representation of the selected one or more homes, a representation of the subset of the second set of homes, and a representation of differences between the selected one or more homes and the subset of the second set of homes. According to aspects, the instructions transmitted at block 1110 may be output to the GUI.

According to aspects, the multi-tiered comparison of block 1106 may include a first tier that compares a distance between the locations of the one or more selected homes and the subset of the second set of homes to a first threshold. According to aspects, the first tier may further include a comparison of a geographic region between the homes. For example, the computing device 102 may determine whether communities are in the same geographic region or not. If not, the computing device 102 may determine whether the geographic regions are comparable. According to aspects, the first threshold may be 20 miles. The first threshold may be adjusted (e.g., increased or decreased) to narrow or broaden the number of potentially comparable homes that may be included in the comparison.

According to aspects, the multi-tiered comparison of block 1106 may include a second tier that compares a difference between the dimensions of the home plans of the one or more selected homes and the dimensions of the home plans of the subset of the second set of homes to a second threshold. For example, the dimensions of the home plans may include or correspond to an area (e.g. the square footage) of the home plans, or the dimensions may include or correspond to a price per unit area (e.g., dollar per square foot) of the home plans. According to aspects, the second threshold may be a percent difference (e.g., 10%, 15%, 20%, etc.) difference between the dimensions of the home plans of the one or more selected homes and the dimensions of the home plans of the subset of the second set of homes.

According to aspects, the multi-tiered comparison of block 1106 may include a third tier that compares a difference between the layouts of the home plans of the one or more selected homes and the layouts of the home plans of the subset of the second set of homes to a third threshold. For example, the layouts of the home plans may include the number of bedrooms, the number of bathrooms, a number of floors, whether the plan includes a garage and the size of the garage, a kitchen configuration, a floorplan type (e.g., open concept, split level, etc.), and/or other relevant plan parameters. According to aspects, the third threshold may be whether a number of bedrooms the subset of the second set of homes are within one bedroom from a number of bedrooms of the one or more selected homes. According to aspects, the third threshold may be whether a number of bathrooms of the second set of homes are within one bathroom from a number of bathrooms of the one or more selected homes.

According to aspects, the multi-tiered comparison of block 1106 may include a fourth tier that compares a difference between a price range of the one or more selected homes and the price range of the subset of the second set of homes to a fourth threshold. For example, according to aspects, the fourth threshold may include a percent difference (e.g., a 20% difference) between the price range of the one or more selected homes and the price range of the subset of the second set of homes.

According to aspects, receiving the home data may include or correspond to receiving a portion of the home data associated with the first set of homes from a data source associated with the particular entity and receiving a portion of the home data associated with the second set of homes from a separate data source from the data source associated with the particular entity.

According to aspects, the GUI may be configured to display the representation of the selected one or more homes and the representation of the subset of the second set of homes on a map.

According to aspects, the layout of the home may includes a number of bedrooms, a number of bathrooms, a number of floors in the respective home, a plan area, or a combination thereof. According to aspects, the plurality of parameter values may include a school district associated with the respective home, a school district rating associated with the school district, a presence of a garage at the respective home, a community amenity associated with the respective home (e.g., a pool, a playground, a tennis court, a community clubhouse, a view, and so on), a completion status of the respective home, a community classification associated with the respective home, or a combination thereof.

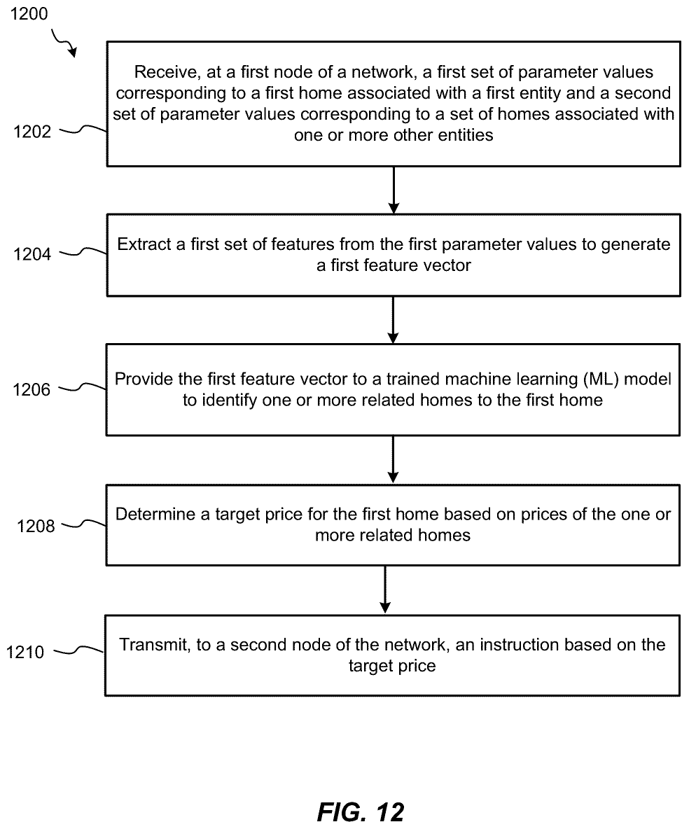

Reference is now made to FIG. 12, which is a flow diagram illustrating an example process 1200 of market comparison and analysis for home builders according to one or more aspects. Operations of process 1200 may be performed by a computing device, such as computing device 102 described above with reference to FIGS. 1-7. For example, example operations (also referred to as “blocks”) of process 1200 may enable computing device 102 to identify and categorize comparisons between homes associated with a home builder and homes associated with one or more third parties. The operations of process 1200 may further be performed by using one or more machine learning models, such as those enabled by classification engine 124 of FIG. 1 and described above with respect to FIG. 7. For example, the process 1200 may enable machine learning-based home comparison and multi-dimensional market analysis of homes.

In block 1202, the computing device 102 may receive, at a first node of a network, a first set of parameter values corresponding to a first home associated with a first entity and a second set of parameter values corresponding to a set of homes associated with one or more other entities. For example, the first home may include or correspond to target home at location 712 of FIG. 7, and the set of homes associated with one or more other entities may include or correspond to the comparable homes at locations 714, 716, and 718. According to aspects, the first set of parameter values may include a home location and a set of home plan data for the first home. For example, the first set of parameter values may include, correspond to, or be derived from home data 110, home status data 112, home sales data 152, and/or home production data 154. According to aspects, the second set of parameter values may include, for each home in the set of homes, a respective home location and a respective set of home plan data. For example, the second set of parameter values may include, correspond to, or be derived from third party data 158 and/or eternal data 162. According to aspects, the respective set of home plan data may include a set of home plan dimension data and a set of home plan layout data. For example, the set of home plan layout data may include a bedroom count, a bathroom count, a garage option attribute, a home amenities attribute, a home type attribute, or a combination thereof. According to aspects, the plurality of parameter values may further include, for the first home and each home of the set of homes, a respective set of geography attributes. For example, the respective set of geography attributes may include a school district attribute, a school district rating attribute, a city attribute, a state attribute, a country attribute, a community amenities attribute, a completion status, an active adult attribute, or a combination thereof.

In block 1204, the computing device 102 may extract a first set of features from the first parameter values to generate a first feature vector. According to aspects, the first feature vector may include a numerical representation of the first set of features extracted from the first parameter values. The first feature vector may include or correspond to feature vectors output from feature extraction engine 122.

In block 1206, the computing device 102 may provide the first feature vector to a trained machine learning (ML) model to identify one or more related homes to the first home. For example, the trained ML model may include or correspond to classification engine 130, as discussed herein. According to aspects, the trained ML model may be configured to assign homes to clusters in a multidimensional feature space based on corresponding features. According to further aspects, the clusters may be defined by proximity between datapoints in the multidimensional space using a supervised learning routine.

In block 1208, the computing device 102 may determine a target price for the first home based on prices of the one or more related homes. For example, in some aspects, determining the target price may include assigning one or more weights to prices of the one or more related homes based on respective distances from locations of the one or more homes to the location of the first home in the multi-dimensional feature space to generate a set of one or more weighted prices. According to some aspects, determining the target price may further include determining a weighted average of the one or more weighted prices.

In block 1210, the computing device 102 may transmit, to a second node of the network, an instruction based on the target price. An instruction may provide a home builder entity with an actionable step to perform. In some implementations, the actionable step indicated by the instruction may be automatically performed by the computing device 102. Non limiting examples of the kinds of instructions that may be transmitted include an instruction to raise or lower a price of the first home, an instruction to make the price of the first home equal to the target price, an instruction to adjust an advertising effort for the first home, an instruction to increase or decrease a construction rate for the first home, a report of the target price, a report of the prices of the one or more related homes a report of a range of prices about the target price, or a combination thereof.

According to aspects, the trained machine learning model may be configured to perform K nearest neighbors clustering.

According to aspects, the one or more related homes may correspond to one or more clusters in the multidimensional feature space having a smallest Euclidean distance to a location in the multidimensional feature space that corresponds to the first home.

According to further aspects, the trained machine learning model may be configured to rank the one or more related homes based on Euclidean distances within the multidimensional feature space from the location corresponding to the first home to locations corresponding to the one or more related homes.

According to aspects, determining the target price may include determining an average of the prices of the one or more related homes. In some implementations, the number of the one or more related homes may be three, but alternative numbers of the one or more related homes may be selected.

According to aspects, the processor (e.g., the one or more processors 104) may be configured to perform steps for training the trained ML model. Training the trained ML model may include extracting a second set of features from each home in the set of homes to generate a plurality of feature vectors and providing the plurality of feature vectors to the trained machine learning model as training inputs.

The flow chart diagrams of FIGS. 8-12 are generally set forth as logical flow chart diagrams. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-7 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented. Parts of this disclosure may use the terms “first,” “second,” “third,” and so on to describe particular elements, steps, or aspects. Unless otherwise explicitly stated otherwise, these terms are intended for ease of understanding and to help keep concepts separate when referring to similar but distinct concepts, and not necessarily to indicate a priority, a preference, an order by which operations (e.g., method steps) are to be performed, or any particular relationship or interaction between the particular elements, steps or aspects.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “and/or” means “and” or “or.” The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, 10, or 20 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A system for intelligently identifying and comparing home builder communities, the system comprising:
a memory; and
a processor coupled to the memory, the processor configured to perform the steps of:
receiving, at a first node of a network, home data corresponding to a first set of homes and a second set of homes, the first set of homes associated with a particular entity and the second set of homes associated with one or more other entities; the home data comprising, for each home of the first set of homes and the second set of homes, a respective plurality of parameter values, where the plurality of parameter values includes a location of the corresponding home, a price range of the corresponding home, dimensions of a home plan of the corresponding home, and a layout of the home plan of the corresponding home;
receiving, at the first node of the network, a user input that indicates a selected one or more homes of the first set of homes;
performing a multi-tiered comparison between a portion of the home data that corresponds to the one or more selected homes and a portion of the home data that corresponds to the second set of homes to generate comparison results;
selecting a subset of the second set of homes based on the comparison results;
transmitting, to a second node of the network, one or more instructions based on the subset of the second set of homes; and
outputting, at the second node of the network, a graphical user interface (GUI) that includes a representation of the selected one or more homes, a representation of the subset of the second set of homes, and a representation of differences between the selected one or more homes and the subset of the second set of homes.

2. The system of claim 1, where the multi-tiered comparison comprises a first tier that compares a distance between the locations of the one or more selected homes and the subset of the second set of homes to a first threshold.

3. The system of claim 2, where the first tier further includes a comparison of a geographic region between the homes.

4. The system of claim 2, where the first threshold is 20 miles.

5. The system of claim 1, where the multi-tiered comparison comprises a second tier that compares a difference between the dimensions of the home plans of the one or more selected homes and the dimensions of the home plans of the subset of the second set of homes to a second threshold, where the second threshold is a 20% difference between the dimensions of the home plans of the one or more selected homes and the dimensions of the home plans of the subset of the second set of homes.

6. The system of claim 1, where the multi-tiered comparison comprises a third tier that compares a difference between the layouts of the home plans of the one or more selected homes and the layouts of the home plans of the subset of the second set of homes to a third threshold, where the third threshold is whether a number of bedrooms and bathrooms of the subset of the second set of homes are within one bedroom from a number of bedrooms of the one or more selected homes or within one bathroom from a number of bathrooms of the one or more selected homes.

7. The system of claim 1, where the multi-tiered comparison comprises a fourth tier that compares a difference between a price range of the one or more selected homes and the price range of the subset of the second set of homes to a fourth threshold, where the fourth threshold is a 20% difference between the price range of the one or more selected homes and the price range of the subset of the second set of homes.

8. The system of claim 1, where receiving the home data comprises:
receiving a portion of the home data associated with the first set of homes from a data source associated with the particular entity; and
receiving a portion of the home data associated with the second set of homes from a separate data source from the data source associated with the particular entity.

9. The system of claim 1, where the GUI is configured to display the representation of the selected one or more homes and the representation of the subset of the second set of homes on a map.

10. The system of claim 1, where the layout of the home further includes a number of bedrooms, a number of bathrooms, a number of floors in the respective home, a plan area, or a combination thereof; and where the plurality of parameter values further includes a school district associated with the respective home, a school district rating associated with the respective home, a presence of a garage at the respective home, a community amenity associated with the respective home, a completion status of the respective home, a community classification associated with the respective home, or a combination thereof.

11. A method for intelligent competitor set identification and comparison for home builder communities, the method comprising:
receiving, at a first node of a network, home data corresponding to a first set of homes and a second set of homes, the first set of homes associated with a particular entity and the second set of homes associated with one or more other entities; the home data comprising, for each home of the first set of homes and the second set of homes, a respective plurality of parameter values, where the plurality of parameter values includes a location of the corresponding home, a price range of the corresponding home, dimensions of a home plan of the corresponding home, and a layout of the home plan of the corresponding home;
receiving, at the first node of the network, a user input that indicates a selected one or more homes of the first set of homes;
performing a multi-tiered comparison between a portion of the home data that corresponds to the one or more selected homes and a portion of the home data that corresponds to the second set of homes to generate comparison results;
selecting a subset of the second set of homes based on the comparison results;
transmitting, to a second node of the network, one or more instructions based on the subset of the second set of homes; and
outputting, at the second node of the network, a graphical user interface (GUI) that includes a representation of the selected one or more homes, a representation of the subset of the second set of homes, and a representation of differences between the selected one or more homes and the subset of the second set of homes.

12. The method of claim 11, where the multi-tiered comparison comprises a first tier that compares a distance between the locations of the one or more selected homes and the subset of the second set of homes to a first threshold.

13. The method of claim 12, where the first tier further includes a comparison of a geographic region between the homes.

14. The method of claim 12, where the first threshold is 20 miles.

15. The method of claim 11, where the multi-tiered comparison comprises a second tier that compares a difference between the dimensions of the home plans of the one or more selected homes and the dimensions of the home plans of the subset of the second set of homes to a second threshold, where the second threshold is a 20% difference between the dimensions of the home plans of the one or more selected homes and the dimensions of the home plans of the subset of the second set of homes.

16. The method of claim 11, where the multi-tiered comparison comprises a third tier that compares a difference between the layouts of the home plans of the one or more selected homes and the layouts of the home plans of the subset of the second set of homes to a third threshold, where the third threshold is whether a number of bedrooms and bathrooms of the subset of the second set of homes are within one bedroom from a number of bedrooms of the one or more selected homes or within one bathroom from a number of bathrooms of the one or more selected homes.

17. The method of claim 11, where the multi-tiered comparison comprises a fourth tier that compares a difference between a price range of the one or more selected homes and the price range of the subset of the second set of homes to a fourth threshold, where the fourth threshold is a 20% difference between the price range of the one or more selected homes and the price range of the subset of the second set of homes.

18. The method of claim 11, where receiving the home data comprises:
receiving a portion of the home data associated with the first set of homes from a data source associated with the particular entity; and
receiving a portion of the home data associated with the second set of homes from a separate data source from the data source associated with the particular entity.

19. The method of claim 11, where the GUI is configured to display the representation of the selected one or more homes and the representation of the subset of the second set of homes on a map.

20. The method of claim 11, where the layout of the home further includes a number of bedrooms, a number of bathrooms, a number of floors in the respective home, a plan area, or a combination thereof; and where the plurality of parameter values further includes a school district associated with the respective home, a school district rating associated with the respective home, a presence of a garage at the respective home, a community amenity associated with the respective home, a completion status of the respective home, a community classification associated with the respective home, or a combination thereof.

21. A computer program product for intelligent competitor set identification and comparison for home builder communities, the computer program product comprising:
a non-transitory computer readable medium comprising code for performing steps comprising:
receiving, at a first node of a network, home data corresponding to a first set of homes and a second set of homes, the first set of homes associated with a particular entity and the second set of homes associated with one or more other entities; the home data comprising, for each home of the first set of homes and the second set of homes, a respective plurality of parameter values, where the plurality of parameter values includes a location of the corresponding home, a price range of the corresponding home, dimensions of a home plan of the corresponding home, and a layout of the home plan of the corresponding home;
receiving, at the first node of the network, a user input that indicates a selected one or more homes of the first set of homes;
performing a multi-tiered comparison between a portion of the home data that corresponds to the one or more selected homes and a portion of the home data that corresponds to the second set of homes to generate comparison results;
selecting a subset of the second set of homes based on the comparison results;
transmitting, to a second node of the network, one or more instructions based on the subset of the second set of homes; and
outputting, at the second node of the network, a graphical user interface (GUI) that includes a representation of the selected one or more homes, a representation of the subset of the second set of homes, and a representation of differences between the selected one or more homes and the subset of the second set of homes.
